(19) United States
(12) Patent Application Publication
(10) Pub. No.: US 2025/0062818 A1
(43) Pub. Date: Feb. 20, 2025

(54) METHODS AND DEVICES FOR COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 18/721,471

(22) PCT Filed: Dec. 20, 2021
(86) PCT No.: PCT/CN2021/139772

§ 371 Date: Jun. 18, 2024

(51) Int. Cl. H04B 7/06; H04L 5/00

(52) U.S. Cl. CPC H04B 7/06964; H04B 7/06968; H04L 5/0094

(57) ABSTRACT

Embodiments of the present disclosure relate to methods, devices and computer storage media for communication. According to this solution, a terminal device detects a beam failure on a first component carrier (CC). The terminal device applies at least one ne quasi co-location (QCL) parameters as the ones associated with a first reference signal for downlink reception on the first CC until a first timing, or applies a spatial domain filter as the one associated with the first reference signal or as for a physical random access channel (PRACH) transmission for uplink transmission on the first CC until the first timing. In this way, the failed CC can still be under control of common beam update/activation.

### TECHNICAL FIELD

Embodiments of the present disclosure generally relate to the field of telecommunication, and in particular, to methods, devices and computer storage media for communication.

### BACKGROUND

In the third generation partnership project (3GPP) meeting RAN #86, it is agreed to support enhancement on multi-beam operation, mainly targeting the frequency range 2 (FR2) while also applicable to the frequency range 1 (FR1). It is agreed to identify and specify features to facilitate more efficient (lower latency and overhead) downlink (DL) and uplink (UL) beam management for intra-cell and inter-cell. For example, it is proposed to support common beam(s) for data and control information transmission/reception for both DL and UL. It is also proposed to support a unified Transmission Configuration Indication (TCI) framework for DL and UL beam indication. Moreover, multi-input multi-output (MIMO) has been proposed, which includes features that facilitate utilization of a large number of antenna elements at a base station for both sub-6 GHZ and over 6-GHz frequency bands. Therefore, it is worth enhancing multi-beam operations.

### SUMMARY

In general, example embodiments of the present disclosure provide methods, devices and computer storage media for communication.

In a first aspect, there is provided a method. The method comprises: detecting, at a terminal device, a beam failure on a first component carrier (CC): receiving, from a network device, a physical downlink control channel (PDCCH) with a first transmission configuration indicator (TCI) state; and applying at least one quasi co-location (QCL) parameters as the ones associated with a first reference signal for downlink reception on the first CC until a first timing, or applying a spatial domain filter as the one associated with the first reference signal or as for a physical random access channel (PRACH) transmission for uplink transmission on the first CC until the first timing.

In a second aspect, there is provided a terminal device. The terminal device comprises circuitry configured to perform the method according to the above first aspect of the present disclosure.

In a third aspect, there is provided a computer program product comprising machine-executable instructions. The machine-executable instructions, when being executed, cause a machine to perform the method according to the above first or second aspect of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example signaling chart in accordance with some embodiments of the present disclosure:

FIG. 3 illustrates a schematic diagram of timings according to examples embodiments of the present disclosure:

FIG. 4 illustrates a schematic diagram of timings according to examples embodiments of the present disclosure:

FIGS. 5A-5B illustrate a schematic diagram of timings according to examples embodiments of the present disclosure;

FIGS. 6A-6B illustrates a schematic diagram of timings according to examples embodiments of the present disclosure;

FIG. 7 illustrate a schematic diagram of timings according to examples embodiments of the present disclosure:

FIGS. 8A-8B illustrates a schematic diagram of timings according to examples embodiments of the present disclosure:

FIG. 9 illustrates a flowchart of an example method in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.” The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has “multicast/broadcast” feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHZ), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

Embodiments of the present disclosure may be performed in test equipment, e.g. signal generator, signal analyzer, spectrum analyzer, network analyzer, test terminal device, test network device, channel emulator

Embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As described above, it has been proposed to evaluate and, if needed, specify beam management related enhancements for carrier aggregation (CA) and inter-cell beam management. However, how to solve beam failure recovery for CA and inter-cell beam management is a big challenge for a reliable communication.

Generally speaking, for uplink (UL) transmission, one TRP usually corresponds to one SRS resource set. As used herein, the term “single-TRP for UL” refers to that a single SRS resource set is used for performing related transmissions (such as, PUSCH transmissions), and the term “multi-TRP for UL” refers to that a plurality of SRS resource sets are used for performing related transmissions (such as, PUSCH transmissions).

As mentioned above, there are enhancements on multi-beam operation, mainly targeting FR2 while also applicable to FR1: a. Identify and specify features to facilitate more efficient (lower latency and overhead) DL/UL beam management for intra-cell and inter-cell scenarios to support higher UE speed and/or a larger number of configured TCI states: i. Common beam for data and control transmission/reception for DL and UL, especially for intra-band CA: ii. Unified TCI framework for DL and UL beam indication: iii. Enhancement on signaling mechanisms for the above features to improve latency and efficiency with more usage of dynamic control signaling (as opposed to RRC): iv. For inter-cell beam management, a UE can transmit to or receive from only a single cell (i.e. serving cell does not change when beam selection is done). This includes L1-only measurement/reporting (i.e. no L3 impact) and beam indication associated with cell(s) with any Physical Cell ID(s): The beam indication is based on Rel-17 unified TCI framework; The same beam measurement/reporting mechanism will be reused for inter-cell mTRP; This work shall only consider intra-Distributed Unit (intra-DU) and intra-frequency cases.

As mentioned above, there are enhancements on multi-beam operation, mainly targeting FR2 while also applicable to FR1: a. Identify and specify features to facilitate more efficient (lower latency and overhead) DL/UL beam management to support higher intra- and L1/L2-centric inter-cell mobility and/or a larger number of configured TCI states; i. Common beam for data and control transmission/reception for DL and UL, especially for intra-band CA: ii. Unified TCI framework for DL and UL beam indication; iii. Enhancement on signaling mechanisms for the above features to improve latency and efficiency with more usage of dynamic control signaling (as opposed to RRC).

It is proposed to support L1-based beam indication using at least UE-specific (unicast) DCI to indicate joint or separate DL/UL beam indication from the active TCI states. The existing DCI formats 1_1 and 1_2 are reused for beam indication and it supports a mechanism for UE to acknowledge successful decoding of beam indication. The ACK/NACK of the PDSCH scheduled by the DCI carrying the beam indication can be used as an ACK also for the DCI.

It is also proposed to support activation of one or more TCI states via medium access control (MAC) control element (CE) analogous to Release. 15/16. At least for the single activated TCI state, the activated TCI state is applied.

For beam indication with Rel-17 unified TCI, support DCI format 1_1/1_2 without DL assignment, acknowledgement/negative acknowledgement (ACK/NACK) mechanism is used analogously to that for semi-persistent scheduling (SPS) PDSCH release with both type-1 and type-2 HARQ-ACK codebook. Upon a successful reception of the beam indication DCI, the UE reports an ACK.

For type-1 HARQ-ACK codebook, a location for the ACK information in the HARQ-ACK codebook is determined based on a virtual PDSCH indicated by the time domain resource allocation (TDRA) field in the beam indication DCI, based on the time domain allocation list configured for PDSCH. For type-2 HARQ-ACK codebook, a location for the ACK information in the HARQ-ACK codebook is determined according to the same rule for SPS release. The ACK is reported in a PUCCH k slots after the end of the PDCCH reception where k is indicated by the PDSCH-to-HARQ_feedback timing indicator field in the DCI format, or provided dl-DataToUL-ACK or dl-DataToUL-ACK-ForDCI-Format1-2-r16 if the PDSCH-to-HARQ_feedback timing indicator field is not present in the DCI.

When used for beam indication, configured scheduling-radio network temporary identifier (CS-RNTI) is used to scramble the CRC for the DCI. The values of the following DCI fields are set as follows: RV=all ‘1's: MCS=all ‘1's: NDI=0; and set to all ‘0's for FDRA Type 0, or all ‘1's for FDRA Type 1, or all ‘0's for dynamicSwitch.

The TCI field can be used to signal the following: 1) Joint DL/UL TCI state, 2) DL-only TCI state (for separate DL/UL TCI), 3) UL-only TCI state (for separate DL/UL TCI).

In addition, the following DCI fields are being used in Rel-16: identifier for DCI formats: carrier indicator: bandwidth part indicator: time domain resource assignment (TDRA): downlink assignment index (if configured): transmit power control (TPC) command for scheduled PUCCH: PUCCH resource indicator: PDSCH-to-HARQ_feedback timing indicator (if present). The remaining unused DCI fields and codepoints are reserved in Release 17.

It is also proposed to support UE to report whether or not to support TCI update by DCI format 1_1/1_2. For a UE supporting TCI update by DCI format 1_1/1_2, it must support TCI update by using DCI 1_1/1_2 with DL assignment, and support of the above feature for TCI update by DCI format 1_1/1_2 without DL assignment is UE optional.

On Rel-17 DCI-based beam indication, regarding application time of the beam indication, the first slot or the first subslot that is at least X ms or Y symbols after the last symbol of the acknowledgment of the joint or separate DL/UL beam indication.

In some embodiments, a slot comprises 14 or 12 Orthogonal Frequency Divided Multiplexing (OFDM) symbols. In some embodiments, a subslot comprises at least one of {2, 4, 7} OFDM symbols.

According to conventional technologies, Transmission configuration indication-0 bit if higher layer parameter tci-PresentInDCI is not enabled: otherwise 3 bits as defined in Clause 5.1.5 of [6, TS38.214]. According to conventional technologies, Transmission configuration indication—0 bit if higher layer parameter tci-PresentDCI-1-2 is not configured: otherwise 1 or 2 or 3 bits determined by higher layer parameter tci-PresentDCI-1-2 as defined in Clause 5.1.5 of [6, TS38.214].

The UE receives an activation command, as described in clause 6.1.3.14 of [10, TS 38.321], used to map up to 8 TCI states to the codepoints of the DCI field ‘Transmission Configuration Indication’ in one Component Carrier (CC)/DL Bandwidth Part (BWP) or in a set of CCs/DL BWPs, respectively: When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2. For example, if the number of bits for the DCI field ‘Transmission Configuration Indication’ of DCI format 1_2 or the number of bits of higher layer parameter tci-PresentDCI-1-2 is 1 bit, then S=2. For another example, if the number of bits for the DCI field ‘Transmission Configuration Indication’ of DCI format 1_2 or the number of bits of higher layer parameter tci-PresentDCI-1-2 is 2 bits, then S=4. For another example, if the number of bits for the DCI field ‘Transmission Configuration Indication’ of DCI format 1_2 or the number of bits of higher layer parameter tci-PresentDCI-1-2 is 3 bits, then S=8.

Moreover, DCI format 1_1/1_2 with and without DL assignment can be used for dynamic beam indication. If beam indication is indicated by DCI format with DL scheduling, ACK/NACK of PDSCH can be used to indicate ACK of the beam indication, and after an application timing, indicated beam can be applied.

However, how to handle the inter-action between per CC BFR and common beam update for CA needs to be defined, to make UE and/or network behavior clear. In case of common beam activation/update for CA, and if beam failure recovery (BFR) is performed per CC, then beam failure recovery procedure in a CC seems to be no relationship with/separate from common beam update (at least for a TCI indicated in DCI on another CC). For example, if a beam failure detected in a first CC, a new beam if found can be detected and be applied after a timing, while if there is a TCI (no matter same or different from previous indicated TCI state) indicated in a DCI on a second CC, this TCI is to be applied to the set of CCs (including first and second CC) after another timing, in case of some duration (e.g. overlapping duration), the inter-action between two procedures should be defined, e.g. which beam should be applied for the first CC. The application of a candidate beam (represented as “q_{new}”) needs to have an until/ending timing, and straightforwardly, the timing is TCI state(s) activation/indication, while position of different timings, status of indicated TCI state (whether changed or not), the type of a CC with beam failure (Spcell, Scell, reference CC, target CC), CC of the indicated TCI state (the DCI is on which kind of CC) will have different impact on the application of beams (q_{new} or new TCI).

In some embodiments, a beam failure which is declared on a cell/CC may be based on the condition that a counter value for a beam failure indication (for example, BFI_COUNTER) is larger than or equal to a maximum value for beam failure (for example, beamFailureInstanceMaxCount) configured for the cell/CC. In some embodiments, the terms “beam failure declared” and “BFI_COUNTER>=beamFailureInstanceMaxCount” may be used interchangeably.

Moreover, if BFR is performed per CC, then after beam failure declared on a CC, BFR is performed, while indication of TCI state (at least) on other CC is still on-going, it is not clear how to define the UE behavior on the indicated TCI state for the failed CC. In current technologies, BFR on a cell will be cancelled after BFR medium access control control element (MAC CE) transmission, and in case of at least DCI based beam update for CA, if new TCI state is to be applied for the failed CC, it seems BFR should be cancelled based on other conditions.

In case of common beam update/activation for CA, it's typical that one common beam is applied for the CCs, and beam failure is detected based on block error rate (BLER) (considering interference). It may be possible that the common beam is not suitable for one CC, but still available on another CC. It may also be with high probability that beam failure occurs on one CC, the common beam is also not quite good for other CCs.

Embodiments of the present disclosure provide a solution to solve the above problem and/or one or more of other potential problems. According to this solution, a terminal device detects a beam failure on a first component carrier (CC). The terminal device applies at least one ne quasi co-location (QCL) parameters as the ones associated with a first reference signal for downlink reception on the first CC until a first timing, or applies a spatial domain filter as the one associated with the first reference signal or as for a physical random access channel (PRACH) transmission for uplink transmission on the first CC until the first timing. In this way, the failed CC can still be under control of common beam update/activation for CA.

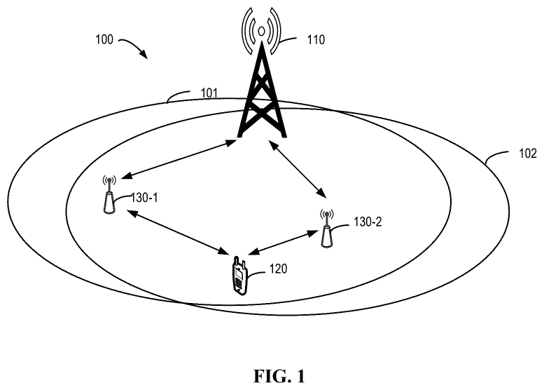

FIG. 1 shows an example communication network 100 in which embodiments of the present disclosure can be implemented. The network 100 includes a network device 110 and a terminal device 120 served by the network device 110. The network 100 may provide one or more serving cells to serve the terminal device 120. It should be noted that the numbers of terminal devices and network device are only examples not limitations.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Remote Radio Unit (RRU), a radio head (RH), a remote radio head (RRH), a low power node such as a femto node, a pico node, and the like.

The communication network 100 further comprises a network device 110. In the communication network 100, the network device 110 and the terminal devices 120 can communicate data and control information to each other. The numbers of devices shown in FIG. 1 are given for the purpose of illustration without suggesting any limitations.

In some scenarios, carrier aggregation (CA) can be supported in the network 100, in which two or more CCs are aggregated in order to support a broader bandwidth. For example, in FIG. 1, the network device 110 may provide to the terminal device 120 a plurality of serving cells including one primary cell (Pcell or Pscell or Spcell) 101 corresponding to a primary CC and at least one secondary cell (Scell) 102 corresponding to at least one secondary CC. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

In some other scenarios, the terminal device 120 may establish connections with two different network devices (not shown in FIG. 1) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (Spcell)” may refer to the Pcell of the MCG or the primary Scell (Pscell) of the SCG depending on if the terminal device 120 is associated to the MCG or the SCG, respectively. In other cases than the Dual Connectivity operation, the term “SpCell” may also refer to the PCell.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit downlink control information (DCI) via a PDCCH and/or transmit data via a PDSCH to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit uplink control information (UCI) via a PUCCH and/or transmit data via a PUSCH to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DMRS, CSI-RS, SRS, PTRS, fine time and frequency TRS and so on. In some embodiments, the terminal device 120 may transmit at least one of HARQ-ACK information, scheduling request (SR) and channel state information (CSI) to the network device 110.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, wireless local network communication protocols such as Institute for Electrical and Electronics Engineers (IEEE) 802.11 and the like. Moreover, the communication may utilize any proper wireless communication technology; comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below:

There are enhancements on multi-beam operation, mainly targeting FR2 while also applicable to FR1: a. Identify and specify features to facilitate more efficient (lower latency and overhead) DL/UL beam management to support higher intra- and L1/L2-centric inter-cell mobility and/or a larger number of configured TCI states: i. Common beam for data and control transmission/reception for DL and UL, especially for intra-band CA: ii. Unified TCI framework for DL and UL beam indication: iii. Enhancement on signaling mechanisms for the above features to improve latency and efficiency with more usage of dynamic control signaling (as opposed to RRC).

As shown in FIG. 1, for example, the network device 110 may communicate with the terminal device 120 via TRPs 130-1 and 130-2 (collectively referred to as “TRPs 130” or individually referred to as “TRP 130” in the following). For example, the TRP 130-1 may be also referred to as the first TRP, while the TRP 130-2 may be also referred to as the second TRP. As described above, the network device 110 may provide a group of cells to serve the terminal device 120. In some embodiments, the group of cells may be divided into a first subset of cells associated with the first TRP 130-1 and a second subset of cells associated with the second TRP 130-2. For example, the first subset of cells and the second subset of cells may include one or more overlapping cells or may not overlap each other.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHZ, an extending NR operation up to 71 GHZ, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity:

It is to be understood that the numbers of network devices, terminal devices and/or TRPs are only for the purpose of illustration without suggesting any limitations to the present disclosure. The communication network 100 may include any suitable number of network devices, terminal devices and/or TRPs adapted for implementing implementations of the present disclosure.

In some embodiments, the TRPs may be explicitly associated with different higher-layer configured identities. For example, a higher-layer configured identity can be associated with a Control Resource Set (CORESET), a group of CORESETs, a reference signal (RS), a set of RS, a Transmission Configuration Indication (TCI) state or a group of TCI states, which is used to differentiate between transmissions between different TRPs and the terminal device 120. When the terminal device 120 receives two DCIs from two CORESETs which are associated with different higher-layer configured identities, the two DCIs may be transmitted or indicated from different TRPs. Further, the TRPs may be implicitly identified by a dedicated configuration to the physical channels or signals. For example, a dedicated CORESET, a RS, and a TCI state, which are associated with a TRP, are used to identify a transmission from a different TRP to the terminal device 120. For example, when the terminal device 120 receives a DCI from a dedicated CORESET, the DCI is indicated from the associated TRP dedicated by the CORESET. In some embodiments, the RS may be at least one of CSI-RS, SRS, positioning RS, uplink DM-RS, downlink DM-RS, uplink PTRS and downlink PTRS.

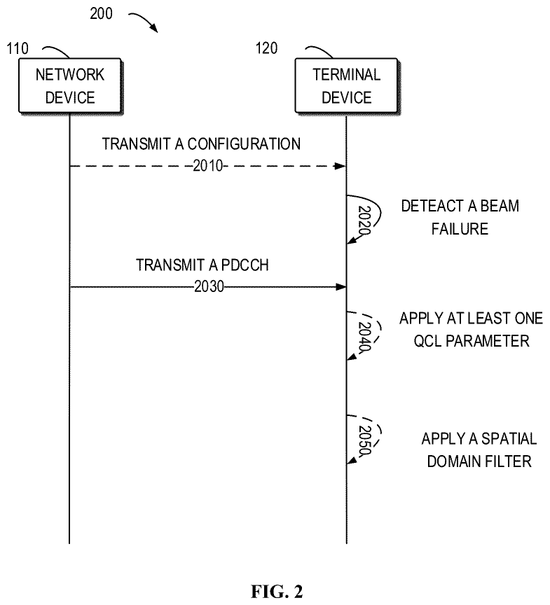

FIG. 2 illustrates a singling chart 200 in accordance with embodiments of the present disclosure. As shown in FIG. 2, the network device 110 may transmit 2010 at least one configuration to the terminal device 120. In some embodiments, the at least one configuration may indicate at least one of: a first list of cells, wherein the first list of cells comprises a first cell and a second list of cells: a reference configuration for at least a first spatial reception parameter of the second list of cells referring to the first cell: a TCI state pool configured in a reference cell; and a set of TCI states. The set of TCI states comprises at least one of: a first subset of TCI states, wherein at least one reference signal (RS) in a TCI state of the first subset is associated with a first physical cell identity (ID). For example, the configuration may be transmitted from the network device 110 to the terminal device 120 via at least one of Radio Resource Control (RRC) signaling, Medium Access Control (MAC) control element (CE) or Downlink Control Information (DCI).

The terminal device 120 may detect 2020 a beam failure on a first CC. For example, the terminal device 120 may be configured with a set of RSs for beam failure detection (RS_{0_0} and RS_{0_1}), and a set of RSs for new/candidate beam identification (RS_{1_0} and RS_{1_1}). In case of RS_{0_0} and RS_{0_1} failed, the terminal device may search new beam based on RS_{1_0} and RS_{1_1}.

In some embodiments, the terminal device 120 may be configured with M TRPs in a bandwidth part (BWP) for a cell, where M is a positive integer. For example, 1≤M≤4. For another example, M=2. In some embodiments, each TRP in the M TRPs may be represented by or associated with at least one of the following: a control resource set (CORESET) pool index: a CORESET group identifier (ID): a group of CORESETs: a CORESET set ID: a set of CORESETs: a SRS resource set: a SRS resource set ID: a TCI state: a group of TCI states: an ID of a set of reference signals (RSs) for beam failure detection: an ID of a set of RSs for new/candidate beam identification: spatial relation information: a group of spatial relation information: a set of QCL parameters: a group of RSs for beam failure detection: a group of RSs for new/candidate beam identification; and so on. In the example as shown in FIG. 1B, M=2. In some embodiments, the first TRP 130-1 may be represented by or associated with at least one of the following: a first CORESET pool index (for example, with a value of 0). For another example, CORESET(s) without configuration of the parameter “CORESET pool index”): a first CORESET group/set/subset ID: a first group/set/subset of CORESETs (For example, CORESET(s) configured with the first CORESET pool index or the first CORESET group/set/subset ID. For another example, CORESET(s) not configured with the parameter “CORESET pool index” or the parameter “CORESET group/set/subset ID”); a first SRS resource set; a first SRS resource set ID: a first TCI state: a first group of TCI states: an ID of a first set of reference signals (RSs) for beam failure detection: the first set of reference signals (RSS) for beam failure detection: an ID of a first set of RSs for new/candidate beam identification; the first set of RSs for new/candidate beam identification: first spatial relation information; a first group of spatial relation information: a first set of QCL parameters: a first group of RSs for beam failure detection: a first group of RSs for new/candidate beam identification; and so on. The second TRP 130-2 may be represented by at least one of the following: a second CORESET pool index (for example, with a value of 1): a second CORESET group/set/subset ID: a second group/set/subset of CORESETs (For example, CORESET(s) configured with the second CORESET pool index or the second CORESET group/set/subset ID.): a second SRS resource set: a second SRS resource set ID: a second TCI state: a second group of TCI states: an ID of a second set of reference signals (RSs) for beam failure detection: the second set of reference signals (RSs) for beam failure detection; an ID of a second set of RSs for new/candidate beam identification; the second set of RSs for new/candidate beam identification: second spatial relation information: a second group of spatial relation information: a second set of QCL parameters: a second group of RSs for beam failure detection: a second group of RSs for new/candidate beam identification; and so on.

In some embodiments, the terminal device 120 may be configured with a first TRP (for example, the first TRP 130-1) and a second TRP (for example, the second TRP 130-2) in a BWP for a cell.

In some embodiments, the terminal device 120 may receive a configuration or an activation command, and the configuration or the activation command is used to map up to 8 combinations of one or two TCI states to a set of TCI codepoints. For example, the number of TCI codepoints in the set of TCI may be at least one of {1, 2, 3, 4, 5, 6, 7, 8, 9, 10, 11, 12, 13, 14, 15, 16}. For example, the set of TCI codepoints are indicated in a DCI field “transmission configuration indication”. In some embodiments, if at least one TCI codepoint indicates two TCI states (for example, a first TCI state and a second TCI state), the terminal device 120 may be served with two TRPs (for example, a first TRP and a second TRP). For example, the first TCI state is associated with the first TRP, and the second TCI state is associated with the second TRP.

In the following, the terms “TRP”, “CORESET pool index”, “CORESET group/set/subset ID”, “group/set/subset of CORESETs”, “SRS resource set”, “SRS resource set ID”, “TCI state”, “group of TCI states”, “ID of a set of RSs for beam failure detection”, “ID of a set of RSs for new/candidate beam identification”, “spatial relation information”, “group of spatial relation information”, “set of QCL parameters”, “QCL parameter(s)”, “QCL assumption”, “QCL configuration”, “group of RSs for beam failure detection” and “group of RSs for new/candidate beam identification” can be used interchangeably. The terms “first TRP”, “first CORESET pool index”, “first CORESET group/set/subset ID”, “first group/set/subset of CORESETs”, “first SRS resource set”, “first SRS resource set ID”, “first TCI state”, “first TCI state of two TCI states corresponding to a TCI codepoint”, “first group of TCI states”, “ID of a first set of RSs for beam failure detection”, “first set of RSs for beam failure detection”, “ID of a first set of RSs for new/candidate beam identification”, “first set of RSs for new/candidate beam identification”, “first spatial relation information”. “first group of spatial relation information”, “first set of QCL parameters”, “first group of RSs for beam failure detection” and “first group of RSs for new/candidate beam identification” can be used interchangeably. The terms “second TRP”, “second CORESET pool index”, “second CORESET group/set/subset ID”, “second group/set/subset of CORESETs”, “second SRS resource set”, “second SRS resource set ID”, “second TCI state”, “second TCI state of two TCI states corresponding to a TCI codepoint”, “second group of TCI states”, “ID of a second set of RSs for beam failure detection”, “second set of RSs for beam failure detection”: “ID of a second set of RSs for new/candidate beam identification”, “second set of RSs for new/candidate beam identification”, “second spatial relation information”, “second group of spatial relation information”, “second set of QCL parameters”, “second group of RSs for beam failure detection” and “second group of RSs for new/candidate beam identification” can be used interchangeably. The terms “PUSCH” and “PUSCH MAC CE” can be used interchangeably. The terms “QCL-TypeD”, “Spatial Rx parameter”, “Spatial receiving parameter” and “Spatial reception parameter” can be used interchangeably. The terms “Pcell”, “Pscell”, “primary cell”, “primary secondary cell”, “primary CC”, “Spcell” and “special cell” can be used interchangeably. The terms “Scell”, “secondary cell” and “secondary CC” can be used interchangeably. The terms “beam”, “TCI state”, “QCL parameter(s)”, “spatial receiving parameter”, “spatial reception parameter”, “spatial Rx parameter”, “spatial relation information”, “spatial filter”, “spatial domain filter” and “spatial relation info” can be used interchangeably. The terms “HARQ”, “HARQ-ACK”, “HARQ-ACK feedback”. “HARQ feedback”, “acknowledgement” and “ACK/NACK” can be used interchangeably.

As specified in the 3GPP specifications (TS 38.214), a UE can be configured with a list of up to M TCI-State configurations within the higher layer parameter PDSCH-Config to decode PDSCH according to a detected PDCCH with DCI intended for the UE and the given serving cell, where M depends on the UE capability max NumberConfiguredTCIstatesPerCC. Each TCI-State contains parameters for configuring a quasi co-location relationship between one or two downlink reference signals and the DM-RS ports of the PDSCH, the DM-RS port of PDCCH or the channel state information reference signal (CSI-RS) port(s) of a CSI-RS resource. The quasi co-location relationship is configured by the higher layer parameter qcl-Type1 for the first downlink (DL) RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command, as described in clause “TCI States Activation/Deactivation for UE-specific PDSCH MAC CE” (for example, clause 6.1.3.14) of [TS 38.321] or in clause “Enhanced TCI States Activation/Deactivation for UE-specific PDSCH MAC CE” (for example, clause 6.1.3) of [TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause “TCI States Activation/Deactivation for UE-specific PDSCH MAC CE” or clause “Enhanced TCI States Activation/Deactivation for UE-specific PDSCH MAC CE” (for example, clause 6.1.3.14 or subclause under 6.1.3) of [TS 38.321], the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, as described in clause 6.1.3.14 and 6.1.3.24 of [10, TS38.321], only the first S activated codepoints are applied for DCI format 1_2.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot or the first subslot that is after slot n+3Nₛₗₒₜ^{subframe,μ} where is the SCS configuration for the PUCCH. If tci-PresentInDCI is set to ‘enabled’ or tci-PresentICI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the synchronization signal/physical broadcast channel (SS/PBCH) block determined in the initial access procedure with respect to qcl-Type set to ‘typeA’, and when applicable, also with respect to qcl-Type set to ‘typeD’.

In some embodiments, if a UE is configured with the higher layer parameter tci-PresentInDCI that is set as ‘enabled’ or tci-PresentInDCI-ForFormat1_2 is configured for the CORESET scheduling the PDSCH, the UE assumes that the TCI field is present in the DCI (for example DCI format 1_1 or DCI format 1_2) of the PDCCH transmitted on the CORESET. If tci-PresentInDCI or tci-PresentInDCI-ForFormat1_2 is not configured for the CORESET scheduling the PDSCH or the PDSCH is scheduled by a DCI (for example, DCI format 1_0), the UE assumes that the TCI field is not present in the DCI (for example DCI format 1_1 or DCI format 1_2 or DCI format 1_0) of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the SS/PBCH block determined in the initial access procedure with respect to ‘QCL-TypeA’, and when applicable, also with respect to ‘QCL-TypeD’. The value of timeDurationForQCL is based on reported UE capability.

If a UE is configured with the higher layer parameter tci-PresentInDCI that is set as ‘enabled’ for the CORESET scheduling the PDSCH, the UE assumes that the TCI field is present in the DCI (for example, DCI format 1_1) of the PDCCH transmitted on the CORESET. If a UE is configured with the higher layer parameter tci-PresentInDCI-ForFormat1_2 for the CORESET scheduling the PDSCH, the UE assumes that the TCI with field field a DCI size indicated by tci-PresentInDCI-ForFormat1_2 is present in the DCI (for example, DCI format 1_2) of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability [TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [TS 38.306]. When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot or the subslot with the scheduled PDSCH, and UE shall expect the activated TCI states are the same across the slots with the scheduled PDSCH. When the UE is configured with CORESET associated with a search space set for cross-carrier scheduling, and the PDCCH carrying the scheduling DCI and the PDSCH scheduled by that DCI are transmitted on the same carrier, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’.
the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enable DefaultTCIStatePerCoresetPoolIndex and the UE is configured by higher layer parameter PDC CH-Config that contains two different values of coresetPoolIndex in different ControlResourceSets.
the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers)
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one component carrier, and the PDSCH scheduled by that DCI is on another component carrier and the UE is configured with enable DefaultBeam-ForCCS:
The timeDurationForQCL is determined based on the subcarrier spacing of the scheduled PDSCH. If μ_{PDCCH}<μ_{PDSCH} an additional timing delay

$$d \frac{{2}^{{μ}_{PDSCH}}}{{2}^{{μ}_{PDCCH}}}$$

is added to the timeDurationForQCL, where d is defined in 5.2.1.5.1a-1, otherwise dis zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in an NZP-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block, or
‘typeC’ with an SS/PBCH block and, when applicable, ‘typeD’ with a CSI-RS resource in an NZP-CSI-RS-ResourceSet configured with higher layer parameter repetition, or

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in a NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with an SS/PBCH block, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeB’ with a CSI-RS resource in a NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in a NZP-CSI-RS-ResourceSet configured with higher layer parameter repetition, or
‘typeC’ with an SS/PBCH block and, when applicable, ‘typeD’ with the same SS/PBCH block.

For the DM-RS of PDCCH, the UE shall expect that a TOI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

For the DM-RS of PDSCH, the UE shall expect that a TCI-State indicates one of the following quasi co-location type(s):
‘typeA’ with a CSI-RS resource in a NZP-CSI-RS-ResourceSet configured with higher layer parameter trs-Info and, when applicable, ‘typeD’ with the same CSI-RS resource, or
‘typeA’ with a CSI-RS resource in a NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in a NZP-CSI-RS-ResourceSet configured without higher layer parameter trs-Info and without higher layer parameter repetition and, when applicable, ‘typeD’ with the same CSI-RS resource.

If the PDCCH carrying the scheduling DCI is received on one component carrier, and the PDSCH scheduled by that DCI is on another component carrier: The timeDurationForQCL is determined based on the subcarrier spacing of the scheduled PDSCH. If pPDCCH<μPDSCH an additional timing delay d is added to the timeDurationForQCL, where d is defined as 8 symbols if subcarrier spacing for the PDCCH is 15 kHz, or 8 symbols if subcarrier spacing for the PDCCH is 30 KHz, or 14 symbols if subcarrier spacing for the PDCCH is 60 KHz. For example, the symbol is PDCCH symbol, or the symbol is based on the subcarrier spacing of PDCCH (for example, as defined in Table 5.2.1.5.1a-1 of TS 38.214); For both the cases when tci-PresentInDCI is set to ‘enabled’ and the offset between the reception of the DL DCI and the corresponding PDSCH is less than the threshold timeDurationForQCL and when tci-PresentInDCI is not configured, the UE obtains its QCL assumption for the scheduled PDSCH from the activated TCI state with the lowest ID applicable to PDSCH in the active BWP of the scheduled cell.

As specified in the 3GPP specifications (TS 38.214), when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DM-RS port(s) within one CDM (Code Domain Multiplexing) group in the DCI field “Antenna Port(s)”. When two TCI states are indicated in a DCI and the UE is set to FDMSchemeA “, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. When two TCI states are indicated in a DCI and the UE is set to FDMSchemeB “, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. When two TCI states are indicated in a DCI and the UE is set to TDMSchemeA “, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214.

When a UE is configured by the higher layer parameter PDSCH-config that indicates at least one entry in pdsch-TimeDomainAllocationList containing RepNumR16 in PDSCH-TimeDomainResourceAllocation, the UE may expect to be indicated with one or two TCI states in a codepoint of the DCI field ‘Transmission Configuration Indication’ together with the DCI field “Time domain resource assignment indicating an entry in pdsch-TimeDomainAllocationList which contain RepNum16 in PDSCH-TimeDomainResourceAllocation and DM-RS port(s) within one CDM group in the DCI field “Antenna Port(s)”. When two TCI states are indicated in a DCI with ‘Transmission Configuration Indication’ field, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. When one TCI state is indicated in a DCI with ‘Transmission Configuration Indication field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with two TCI states in a codepoint of the DCI field ‘Transmission Configuration Indication’ and DM-RS port(s) within two CDM groups in the DCI field “Antenna Port(s)”, the UE may expect to receive a single PDSCH where the association between the DM-RS ports and the TCI states are as defined in Clause “DM-RS reception procedure” (for example, clause 5.1.6.2) in TS 38.214.

When a UE is not indicated with a DCI that DCI field “Time domain resource assignment′ indicating an entry in pdsch-TimeDomainAllocationList which contain RepNumR16 in PDSCH-TimeDomainResourceAllocation, and it is indicated with one TCI states in a codepoint of the DCI field ‘Transmission Configuration Indication’, the UE procedure for receiving the PDSCH upon detection of a PDCCH follows Clause “UE procedure for receiving the physical downlink shared channel” (for example, Clause 5.1) in TS 38.214.

In the following, the terms “FDMSchemeA” and “Scheme 2a” can be used interchangeably: The terms “FDMSchemeB” and “Scheme 2b” can be used interchangeably. The terms “TDMSchemeA” and “Scheme 3” can be used interchangeably. The terms “RepNumR16” and “Scheme 4” can be used interchangeably.

As specified in the 3GPP specifications (TS 38.214), when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI. If two TCI states are indicated by the DCI field ‘Transmission Configuration Indication’, the UE is expected to receive two PDSCH transmission occasions, where the first TCI state is applied to the first PDSCH transmission occasion and resource allocation in time domain for the first PDSCH transmission occasion follows Clause “Resource allocation in time domain” (for example, clause 5.1.2.1) in TS 38.214. The second TCI state is applied to the second PDSCH transmission occasion, and the second PDSCH transmission occasion shall have the same number of symbols as the first PDSCH transmission occasion. If the UE is configured by the higher layers with a value K̅ in StartingSymbolOffsetK, it shall determine that the first symbol of the second PDSCH transmission occasion starts after K̅ symbols from the last symbol of the first PDSCH transmission occasion. If the value K is not configured via the higher layer parameter StartingSymbolOffsetK. K̅=0 shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n=0, 1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214.

As specified in the 3GPP specifications (TS 38.214), when a UE configured by the higher layer parameter PDSCH-config that indicates at least one entry in pdsch-TimeDomainAllocationList contain RepNumR16 in PDSCH-TimeDomainResourceAllocation. If two TCI states are indicated by the DCI field Transmission Configuration Indication together with the DCI field “Time domain resource assignment′ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV (Start and length indicator value) is applied for all PDSCH transmission occasions, the first TCI state is applied to the first PDSCH transmission occasion and resource allocation in time domain for the first PDSCH transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state is applied to the second PDSCH transmission occasion. When the value indicated by RepNumR16 in PDSCH-TimeDomainResourceAllocation is larger than two, the UE may be further configured to enable CycMapping or SeqMapping in RepTCIMapping. When CycMapping is enabled, the first and second TCI states are applied to the first and second PDSCH transmission occasions, respectively, and the same TCI mapping pattern continues to the remaining PDSCH transmission occasions. When SeqMapping is enabled, first TCI state is applied to the first and second PDSCH transmissions, and the second TCI state is applied to the third and fourth PDSCH transmissions, and the same TCI mapping pattern continues to the remaining PDSCH transmission occasions. The UE may expect that each PDSCH transmission occasion is limited to two transmission layers. For all PDSCH transmission occasions associated with the first TCI state, the redundancy version to be applied is derived according to Table 5.1.2.1-2 [TS 38.214], where n is counted only considering PDSCH transmission occasions associated with the first TCI state. The redundancy version for PDSCH transmission occasions associated with the second TCI state is derived according to Table 5.1.2.1-3 [TS 38.214], where additional shifting operation for each redundancy version rvs is configured by higher layer parameter RVSeqOffset and n is counted only considering PDSCH transmission occasions associated with the second TCI state. If one TCI state is indicated by the DCI field ‘Transmission Configuration Indication’ together with the DCI field “Time domain resource assignment′ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first PDSCH transmission occasion follows Clause “Resource allocation in time domain” (for example, clause 5.1.2.1) in TS 38.214, the same TCI state is applied to all PDSCH transmission occasions. The UE may expect that each PDSCH transmission occasion is limited to two transmission layers. For all PDSCH transmission occasions, the redundancy version to be applied is derived according to Table 5.1.2.1-2 [TS 38.214], where n is counted considering PDSCH transmission occasions. Otherwise, the UE is expected to receive a single PDSCH transmission occasion, and the resource allocation in the time domain follows Clause “Resource allocation in time domain” (for example, clause 5.1.2.1) in TS 38.214.

TABLE 5.1.2.1-2
Applied redundancy version when pdsch-
AggregationFactor is present

| rv_{id} indicated | |
|---|---|
| by the DCI | rv_{id} to be applied to n^{th} transmission occasion |

| scheduling | n mod | n mod | n mod | n mod |
|---|---|---|---|---|
| the PDSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 5.1.2.1-3
Applied redundancy version for the second
TCI state when RVSeqOffset is present

| rv_{id} indicated | rv_{id} to be applied to n^{th} transmission | | | |
|---|---|---|---|---|
| by the DCI | occasion with second TCI state | | | |
| scheduling | n mod | n mod | n mod | n mod |
| the PDSCH | 4 = 0 | 4 = 1 | 4 = 2 | 4 = 3 |
| 0 | (0 + rvₛ) | (2 + rvₛ) | (3 + rvₛ) | (1 + rvₛ) |
| | mod 4 | mod 4 | mod 4 | mod 4 |
| 2 | (2 + rvₛ) | (3 + rvₛ) | (1 + rvₛ) | (0 + rvₛ) |
| | mod 4 | mod 4 | mod 4 | mod 4 |
| 3 | (3 + rvₛ) | (1 + rvₛ) | (0 + rvₛ) | (2 + rvₛ) |
| | mod 4 | mod 4 | mod 4 | mod 4 |
| 1 | (1 + rvₛ) | (0 + rvₛ) | (2 + rvₛ) | (3 + rvₛ) |
| | mod 4 | mod 4 | mod 4 | mod 4 |

As specified in the 3GPP specifications (TS 38.214), For a UE configured by the higher layer parameter RepSchemeEnabler set to ‘FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”. If P′_{BWP,i} is determined as “wideband”, the first

$$⌈ \frac{{n}_{PRB}}{2} ⌉$$

PRBs are assigned to the first TCI state and the remaining

$$⌊ \frac{{n}_{PRB}}{2} ⌋$$

PRBs are assigned to the second TCI state, where npRB is the total number of allocated PRBs for the UE. If P′_{BWP,i} is determined as one of the values among {2, 4}, even PRGs within the allocated frequency domain resources are assigned to the first TCI state and odd PRGs within the allocated frequency domain resources are assigned to the second TCI state. The UE is not expected to receive more than two PDSCH transmission layers for each PDSCH transmission occasion.

For a UE configured by the higher layer parameter RepSchemeEnabler set to ‘FDMSchemeB’, and when the UE is indicated with two TCI states in a codepoint of the DCI field ‘Transmission Configuration Indication and DM-RS port(s) within one CDM group in the DCI field “Antenna Port(s)”, each PDSCH transmission occasion shall follow the Clause “Physical downlink shared channel” (for example Clause 7.3.1) of [TS 38.211] with the mapping to resource elements determined by the assigned PRBs for corresponding TCI state of the PDSCH transmission occasion, and the UE shall only expect at most two code blocks per PDSCH transmission occasion when a single transmission layer is scheduled and a single code block per PDSCH transmission occasion when two transmission layers are scheduled. For two PDSCH transmission occasions, the redundancy version to be applied is derived according to Table 5.1.2.1-2 of [TS 38.214], where n=0, 1 are applied to the first and second TCI state, respectively.

As specified in the 3GPP specifications (TS 38.213), for a CORESET other than a CORESET with index 0,
if a UE has not been provided a configuration of TCI state(s) by tci-StatesPDCCH-ToAddList and tci-StatesPDCCH-ToReleaseList for the CORESET, or has been provided initial configuration of more than one TCI states for the CORESET by tci-StatesPDCCH-ToAddList and tci-StatesPDCCH-ToReleaseList but has not received a MAC CE activation command for one of the TCI states, the UE assumes that the DM-RS antenna port associated with PDCCH receptions is quasi co-located with the SS/PBCH block the UE identified during the initial access procedure:
if a UE has been provided a configuration of more than one TCI states by tci-StatesPDCCH-ToAddList and tci-StatesPDCCH-ToReleaseList for the CORESET as part of Reconfiguration with sync procedure but has not received a MAC CE activation command for one of the TCI states, the UE assumes that the DM-RS antenna port associated with PDCCH receptions is quasi co-located with the SS/PBCH block or the CSI-RS resource the UE identified during the random access procedure initiated by the Reconfiguration with sync procedure.

In some embodiments, for a CORESET with index 0, the UE assumes that a DM-RS antenna port for PDCCH receptions in the CORESET is quasi co-located with
the one or more DL RS configured by a TCI state, where the TCI state is indicated by a MAC CE activation command for the CORESET, if any, or
a SS/PBCH block the UE identified during a most recent random access procedure not initiated by a PDCCH order that triggers a contention-free random access procedure, if no MAC CE activation command indicating a TCI state for the CORESET is received after the most recent random access procedure.

In some embodiments, for a CORESET other than a CORESET with index 0, if a UE is provided a single TCI state for a CORESET, or if the UE receives a MAC CE activation command for one of the provided TCI states for a CORESET, the UE assumes that the DM-RS antenna port associated with PDCCH receptions in the CORESET is quasi co-located with the one or more DL RS configured by the TCI state. For a CORESET with index 0, the UE expects that a CSI-RS configured with qcl-Type set to ‘typeD’ in a TCI state indicated by a MAC CE activation command for the CORESET is provided by a SS/PBCH block, and if the UE receives a MAC CE activation command for one of the TCI states, the UE applies the activation command in the first slot that is after slot k+3Nₛₗₒₜ^{subframe,μ} where k is the slot where the UE would transmit a PUCCH with HARQ-ACK information for the PDSCH providing the activation command and u is the SCS configuration for the PUCCH. The active BWP is defined as the active BWP in the slot when the activation command is applied.

In some embodiments, if a UE is configured for single cell operation or for operation with carrier aggregation in a same frequency band, and monitors PDCCH candidates in overlapping PDCCH monitoring occasions in multiple CORESETs that have been configured with same or different qcl-Type set to ‘typeD’ properties on active DL BWP(s) of one or more cells, then the UE monitors PDCCHs only in a CORESET, and in any other CORESET from the multiple CORESETs that have been configured with qcl-Type set to same ‘typeD’ properties as the CORESET, on the active DL BWP of a cell from the one or more cells
the CORESET corresponds to the CSS set with the lowest index in the cell with the lowest index containing CSS, if any: otherwise, to the USS set with the lowest index in the cell with lowest index
the lowest USS set index is determined over all USS sets with at least one PDCCH candidate in overlapping PDCCH monitoring occasions
for the purpose of determining the CORESET, a SS/PBCH block is considered to have different QCL ‘typeD’ properties than a CSI-RS
for the purpose of determining the CORESET, a first CSI-RS associated with a SS/PBCH block in a first cell and a second CSI-RS in a second cell that is also associated with the SS/PBCH block are assumed to have same QCL ‘typeD’ properties
the allocation of non-overlapping CCEs and of PDCCH candidates for PDCCH monitoring is according to all search space sets associated with the multiple CORESETs on the active DL BWP(s) of the one or more cells
the number of active TCI states is determined from the multiple CORESETs.

In some embodiments, if a UE is configured for single cell operation or for operation with carrier aggregation in a same frequency band, and monitors PDCCH candidates in overlapping PDCCH monitoring occasions in multiple CORESETs where none of the CORESETs has TCI-states configured with qcl-Type set to ‘typeD’, then the UE is required to monitor PDCCH candidates in overlapping PDCCH monitoring occasions for search space sets associated with different CORESETs.

In some embodiments, there is an application timing for beam indication or TCI state(s) indication. In some embodiments, the application timing may be the first slot or first subslot that is at least X ms or Y symbols after the last symbol of the acknowledge of the joint or separate DL/UL beam indication. For example, Y may be integer, and 1<=Y<=336. In some embodiments, slot may include 12 or 14 symols. In some embodiments, subslot may include S symbols. S is integer, and 1<=S<=14. For example, S may be at least one of {2, 4, 7}. In some embodiments, the beam indication is indicated in a DCI in a PDCCH. For example, the DCI in the PDCCH may schedule a PDSCH or may not schedule a PDSCH. In some embodiments, the gap between the last symbol of the DCI and the first slot or the first subslot shall satisfy the capability for the terminal device. In some embodiments, the acknowledge of the joint or separate DL/UL beam indication may be the acknowledge of the PDSCH scheduled by the DCI. For example, when the DCI schedules the PDSCH. In some embodiments, the acknowledge of the joint or separate DL/UL beam indication may be the acknowledge of the DCI. For example, when the DCI doesn't schedule a PDSCH.

In some embodiments, the terminal device may receive or detect a DCI (for example, represented as “DCI_t”) in a PDCCH, and the DCI indicates a joint DL/UL TCI state or a separate DL/UL TCI state or a DL TCI state or a UL TCI state or a pair of DL/UL TCI states. In some embodiments, a first time threshold may indicate a predetermined/configured time period after the first or last symbol of the PDCCH or the first or last symbol of the acknowledge of the indication. In some embodiments, the indicated joint DL/UL TCI state or separate DL/UL TCI state or DL TCI state or UL TCI state or the pair of DL/UL TCI states may be applied to PDSCH and/or CORESET and/or PUSCH and/or PUCCH and/or uplink RS and/or downlink RS after the application timing or the first time threshold. For example, when a joint DL/UL TCI state is indicated in the DCI, the joint DL/UL TCI state may be applied to PDSCH and/or CORESET and/or PUSCH and/or PUCCH and/or uplink RS and/or downlink RS after the application timing or the first time threshold. For another example, when a DL TCI state is indicated in the DCI, the DL TCI state may be applied to PDSCH and/or CORESET and/or downlink RS after the application timing or the first time threshold. For another example, when an UL TCI state is indicated in the DCI, the UL TCI state may be applied to PUSCH and/or PUCCH and/or uplink RS after the application timing or the first time threshold. For another example, when a pair of DL/UL TCI states are indicated in the DCI, the DL TCI state may be applied to PDSCH and/or CORESET and/or downlink RS after the application timing or the first time threshold, and the UL TCI state may be applied to PUSCH and/or PUCCH and/or uplink RS after the application timing or the first time threshold.

In some embodiments, the terminal device 120 may receive an indication to indicate a downlink TCI state (or a beam or a set of QCL parameters), and the source reference signal(s) in the TCI state provides QCL information at least for reception on PDSCH and all of CORESETs in a component carrier (CC). For example, the PDSCH is dedicated or UE-specific.

In some embodiments, the terminal device 120 may receive an indication to indicate an uplink TCI state (or a beam or a spatial relation), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific.

In some embodiments, the terminal device 120 may receive an indication to indicate a joint TCI state (or a beam or a set of QCL parameters), and the TCI state refers to at least a common source reference signal used for determining both the downlink QCL information and the uplink transmission spatial filter.

In some embodiments, the terminal device 120 may receive an indication to indicate a downlink TCI state (or a beam or a set of QCL parameters) and an uplink TCI state (or a beam or a spatial relation), and the source reference signal(s) in the DL TCI state provides QCL information at least for reception on PDSCH and all of CORESETs in a component carrier (CC), and the source reference signal(s) in the TCI state provides a reference for determining uplink transmission spatial filter at least for dynamic grant or configured grant based PUSCH, and all of PUCCH resources in a CC. For example, the PUCCH is dedicated or UE-specific. For another example, the PDSCH is dedicated or UE-specific.

In some embodiments, the terminal device 120 may be configured with more than one (For example, represented as M, M is positive integer. For example, M may be 2 or 3 or 4) downlink TCI states, and/or the terminal device 120 may receive an indication to indicate one of the M TCI states, and the source reference signal(s) in the one of the M TCI states or in the indicated one TCI state provides QCL information at least for reception on PDSCH and/or a subset of CORESETs in a CC. For example, the PDSCH is dedicated or UE-specific.

In some embodiments, the terminal device 120 may be configured with more than one (For example, represented as N, N is positive integer. For example, N may be 2 or 3 or 4) uplink TCI states, and/or the terminal device 120 may receive an indication to indicate one of the N TCI states, and the source reference signal(s) in the one of the N TCI states or in the indicated one TCI state provides a reference for determining uplink transmission spatial filter at least for dynamic grant or configured grant based PUSCH, and/or a subset of PUCCH resources in a CC. For example, the PUCCH is dedicated or UE-specific.

In some embodiments, the terminal device 120 may be configured with more than one (For example, represented as M. M is positive integer. For example, M may be 2 or 3 or 4) joint DL/UL TCI states, and/or receive an indication to indicate one from the M joint TCI states, and each one of the M TCI states or the indicated one TCI state refers to at least a common source reference signal used for determining both the downlink QCL information and the uplink transmission spatial filter.

In some embodiments, synchronization signal/physical broadcast channel (SS/PBCH) block may be represented as SSB in this disclosure.

In some embodiments, the terminal device 120 may be configured with more than one (For example, represented as M, M is positive integer. For example, M may be 2 or 3 or 4) downlink TCI states and the terminal device 120 may be configured with more than one (For example, represented as N, N is positive integer. For example, N may be 2 or 3 or 4) uplink TCI states, and/or the terminal device 120 may receive an indication to indicate one from the M downlink TCI states and one from the N uplink TCI states, and the source reference signal(s) in each one of the M DL TCI states or the indicated one DL TCI state provides QCL information at least for reception on PDSCH and/or a subset of CORESETs in a component carrier (CC), and the source reference signal(s) in each one of the N TCI states or in the indicated one UL TCI state provides a reference for determining uplink transmission spatial filter at least for dynamic grant or configured grant based PUSCH, and/or a subset of PUCCH resources in a CC. For example, the PUCCH is dedicated or UE-specific. For another example, the PDSCH is dedicated or UE-specific.

In the following, DCI_t may be used to describe the DCI for joint DL/UL TCI state indication or for separate DL/UL TCI state indication. In the following, the terms “DCI”, “PDCCH”, “DCI_t”, “DCI for joint DL/UL TCI state indication”, “DCI for separate DL/UL TCI state indication”, “DCI for DL TCI state indication”, “DCI for UL TCI state indication”, “PDCCH for joint DL/UL TCI state indication”, “PDCCH for separate DL/UL TCI state indication”, “PDCCH for DL TCI state indication”, “PDCCH for UL TCI state indication”, “DCI for TCI state indication” and “PDCCH for TCI state indication” can be used interchangeably.

In some embodiments, a DCI may be used for indicating a TCI state for joint DL/UL TCI state indication or for separate DL/UL TCI state indication. And the DCI may schedule a PDSCH (for example, DCI format 1_1 and format 1_2). In some embodiments, the HARQ of the PDSCH scheduled by the DCI can be used as an ACK for the DCI. For example, the DCI may be DCI_t.

In some embodiments, a DCI may be used for indicating a TCI state for joint DL/UL TCI state indication or for separate DL/UL TCI state indication. And the DCI may not schedule a PDSCH (for example, DCI format 1_1 and format 1_2). In some embodiments, a HARQ of the DCI may be introduced to indicate whether the DCI or the TCI state indication is successful. For example, the DCI may be DCI_t.

In some embodiments, if decoding of DCI_t or decoding of the PDSCH scheduled by DCI_t is ACK, the indicated TCI state may be applied for PDSCH and/or all or subset of CORESETs after the application timing.

In some embodiments, a DCI (for example, DCI_t) may be used for indicating one or more TCI states. For example, the one or more TCI states are for joint DL/UL TCI state indication or for separate DL/UL TCI state indication. And the DCI may not schedule a PDSCH (for example, DCI format 1_1 and format 1_2). In some embodiments, upon a successful reception/decoding of the DCI, the terminal device 120 may report an ACK. In some embodiments, upon a failed reception/decoding of the DCI, the terminal device 120 may report a NACK. For example, the ACK and/or NACK may be reported in a physical uplink control channel (PUCCH) or a physical uplink shared channel (PUSCH). In some embodiments, the terminal device 120 may be configured with a type of HARQ codebook. For example, the type may be at least one of Type 1 (for example, semi-static), Type 2 (for example, dynamic) and Type 3 (one shot feedback). For example, the type may be configured via at least one of RRC, MAC CE and DCI. In some embodiments, the DCI is received/detected in a PDCCH.

In some embodiments, the terminal device 120 may be configured/indicated with a first TCI state for reception of PDSCH and/or all or a subset of CORESETs. And the terminal device 120 may receive or detect a PDCCH with the first TCI state, and the PDCCH is in a first CORESET. In some embodiments, the terminal device 120 may be indicated with a second TCI state in the DCI received or detected in the first PDCCH. In some embodiments, the DCI in the PDCCH may schedule or may not schedule a first PDSCH or a first PUSCH. In some embodiments, the terminal device 120 may report the decoding result or HARQ-ACK information for at least one of the DCI or the PDCCH or the first PDSCH to the network device 110. For example, the decoding result or the HARQ-ACK information may be transmitted/reported in a PUCCH or in a second PUSCH. In some embodiments, after the application timing or after the first time threshold, the terminal device 120 may receive PDSCH and/or all or the subset of CORESETs with the second TCI state. For example, the terminal device 120 may receive another PDCCH with the second TCI state, and the other PDCCH is in a second CORESET. For another example, the terminal device 120 may receive another PDCCH with the second TCI state, and the other PDCCH is in the first CORESET.

In some embodiments, the terminal device 120 may receive an indication of a first TCI state, wherein the one or two RSs in the first TCI state may be associated with a first physical cell identity (ID). In some embodiments, the terminal device 120 may monitor or receive a first PDCCH in a first monitoring occasion for a first search space and/or associated scheduling or PDSCH scheduled by the first PDCCH based on a second TCI state or based on a quasi co-location (QCL) assumption, wherein the one or two RSs in the second TCI state and/or the QCL assumption may be associated with a second physical cell ID. In some embodiments, the terminal device 120 may monitor or receive a second PDCCH in a second monitoring occasion for a second search space and/or associated scheduling scheduled by the second PDCCH based on a condition.

In some embodiments, the scheduling may be at least one of: PDSCH, PUSCH, PUCCH, HARQ feedback, CSI-RS, SRS, downlink DM-RS, uplink DM-RS, downlink PTRS, uplink PTRS and TRS.

In some embodiments, the terminal device 120 may receive at least one configuration for a list of cells/CCs. For example, there may be at least one reference cell/CC in the list.

In some embodiments, the terminal device 120 may receive at least one configuration for a set of unified TCI states. For example, there may be T unified TCI states in the set, and T is a positive integer. For example, 1<=T<=192. For another example, 1<=T<=128. In some embodiments, one unified TCI state may be a joint TCI state, or a downlink TCI state, or an uplink TCI state, or a pair of DL TCI state and UL TCI state. In some embodiments, the unified TCI state may provide a reference signal for quasi co-location for DMRS of PDSCH and/or DMRS for PDCCH and/or CSI-RS in at least one cell/CC of the list of cells/CCs, for example, when the unified TCI state is a joint TCI state or a downlink TCI state. In some embodiments, the unified TCI state may provide a reference signal for quasi co-location for DMRS of PDSCH and/or DMRS for PDCCH and/or CSI-RS in the list of cells/CCs. In some embodiments, the unified TCI state may provide a reference for determining uplink transmission spatial filter for PUSCH and/or PUCCH resource and/or SRS in at least one cell/CC of the list of cells/CCs, for example, when the unified TCI state is a joint TCI state or an uplink TCI state. In some embodiments, if at least one configuration for at least one unified TCI states is absent in a bandwidth part (BWP) of a cell/CC or absent in the cell/CC, the terminal device 120 may apply at least one configuration for at least one unified TCI states from a reference BWP of a reference cell/CC or from a reference cell/CC.

In some embodiments, the terminal device 120 may receive at least one activation command for a subset of unified TCI states. For example, there may be T_act unified TCI states in the subset, and T_act is a positive integer. For example, 1<=T_act<=16. For another example, 1<=T_act<=8. In some embodiments, the terminal device 120 may receive at least one activation command, and the at least one activation command may be applied/used to map up to 8 or 16 unified TCI states to codepoints of a DCI field “Transmission configuration indication” for one cell/CC or the list of cells/CCs. For example, one codepoint of the DCI field may correspond to a joint TCI state. For another example, one codepoint of the DCI field may correspond to a pair of DL TCI state and UL TCI state. For another example, one codepoint of the DCI field may correspond to a DL TCI state. For another example, one codepoint of the DCI field may correspond to a UL TCI state.

In some embodiments, the terminal device 120 may receive an indication of TCI state(s) in a DCI. In some embodiments, the terminal device 120 may transmit a PUCCH with HARQ-ACK information corresponding to the DCI carrying the indication (for example, the DCI may be without DL assignment) and/or corresponding to a PDSCH scheduled by the DCI carrying the indication (for example, the DCI may be with DL assignment), the indicated TCI state(s) may be applied starting from an application timing for the indicated TCI state(s). In some embodiments, the application timing may be the first slot that is at least Y symbols after the last symbol of the PUCCH. For example, the HARQ-ACK information may be ACK or acknowledge. In some embodiments, the indicated TCI state(s) may be applied if at least one of the indicated TCI state(s) is different from at least one of the previously indicated TCI states.

In some embodiments, the terminal device 120 may receive an indication of a TCI state in a DCI. For example, the TCI state may be a joint TCI state. In some embodiments, the terminal device 120 may transmit a PUCCH with HARQ-ACK information corresponding to the DCI carrying the indication (for example, the DCI may be without DL assignment) and/or corresponding to a PDSCH scheduled by the DCI carrying the indication (for example, the DCI may be with DL assignment), the indicated TCI state may be applied starting from an application timing for the indicated TCI state. In some embodiments, the application timing may be the first slot that is at least Y symbols after the last symbol of the PUCCH. For example, the HARQ-ACK information may be ACK or acknowledge. In some embodiments, the indicated TCI state may be applied if the indicated TCI state is different from the previously indicated TCI state.

In some embodiments, the terminal device 120 may receive an indication of a DL TCI state and/or a UL TCI state in a DCI. In some embodiments, the terminal device 120 may transmit a PUCCH with HARQ-ACK information corresponding to the DCI carrying the indication (For example, the DCI may be without DL assignment) and/or corresponding to a PDSCH scheduled by the DCI carrying the indication (for example, the DCI may be with DL assignment), the indicated DL TCI state and/or UL TCI state may be applied starting from an application timing for the indicated DL TCI state and/or UL TCI state. In some embodiments, the application timing may be the first slot that is at least Y symbols after the last symbol of the PUCCH. For example, the HARQ-ACK information may be ACK or acknowledge. In some embodiments, the indicated DL TCI state and/or UL TCI state may be applied if the indicated DL TCI state is different from the previously indicated DL TCI state and/or if the indicated UL TCI state is different from the previously indicated UL TCI state.

In some embodiments, the first slot and/or the Y symbols may be determined based on the carrier/cell/CC with the smallest subcarrier spacing (SCS) among the carrier(s)/cells/CCs applying the indication. For example, among the list of cells/CCs.

In some embodiments, if the terminal device 120 detects beam failure in a cell/CC, after X symbols from the last symbol of a beam failure recovery response (BFRR) (for example, the terminal device 120 may receive the BFRR from the network device 110), the terminal device 120 may assume the same QCL parameters as the ones associated with a reference signal or an index for the reference signal for all PDSCH and/or PDCCH receptions in the cell/CC. For example, the same QCL parameters may apply to other signals/channels configured to share/apply the same indicated unified TCI state(s) as the PDSCH and/or PDCCH reception.

In some embodiments, if the terminal device 120 detects beam failure in a cell/CC, after X symbols from the last symbol of a BFRR (for example, the terminal device 120 may receive the BFRR from the network device 110), the terminal device 120 may assume the same UL spatial filter as the one associated with the reference signal or the index for the reference signal or the last physical random access channel (PRACH) transmission for all PUSCH and/or PUCCH resources in the cell/CC. For example, the same UL spatial filter may apply to other signals/channels configured to share/apply the same indicated unified TCI state(s) as the PUSCH and/or PUCCH resources. In some embodiments, the last PRACH transmission may be the latest one before the BFRR.

In some embodiments, the reference signal may be a CSI-RS or a synchronization signal/physical broadcast (SS/PBCH) block. In some embodiments, the index of the reference signal may be provided or transmitted to the network device 110 for beam failure recovery: For example, the index of the reference signal may be q_{new}.

In some embodiments, X is a positive integer. For example, X may be at least one of {7, 14, 28, 48, 56, 224, 336}.

In some embodiments, the BFRR may be a DCI with cyclic redundancy check (CRC) scrambled by cell-radio network temporary identifier (C-RNTI) or modulation coding scheme cell radio network temporary identifier (MCS-C-RNTI) or a PDCCH reception that determines the completion of the contention based random access procedure or a PDCCH reception with a DCI scheduling a PUSCH with a same HARQ process number as for the transmission of a first PUSCH (For example, the terminal device 120 may provide or transmit the first PUSCH with index(es) for at least one of corresponding Scell(s) with radio link quality worse than Q_{out,I,R}, indication(s) of presence of q_{new} for corresponding Scell(s) and index(es) q_{new} for a periodic CSI-RS configuration or for a SS/PBCH block provided by higher layers, if any, for corresponding Scell(s)) and having a toggled new data indication (NDI) field value.

In some embodiments, the terminal device 120 may be provided a configuration of unified TCI state (for example, TCI_State_r17) indicating a unified TCI state for a Pcell or a Pscell. In some embodiments, in case of a beam failure occurs or is detected in the Pcell or Pscell, after X symbols from a last symbol of a first PDCCH reception in a search space set (for example, provided by recovery SearchSpaceld) where the terminal device 120 detects a DCI with CRC scrambled by C-RNTI or MCS-C-RNTI, the terminal device 120 may monitor PDCCH in CORESETs, and/or receive PDSCH and/or aperiodic CSI-RS in a resource from a CSI-RS resource set (for example, the CSI-RS may share/apply the same indicated unified TCI state as for the PDCCH and/or PDSCH), using the same antenna port quasi co-location parameters as the ones associated with the index for the reference signal or with the reference signal. In some embodiments, in case of a beam failure occurs or is detected in a Pcell or Pscell, after X symbols from a last symbol of a first PDCCH reception in a search space set (for example, provided by recovery SearchSpaceld) where the terminal device 120 detects a DCI with CRC scrambled by C-RNTI or MCS-C-RNTI, the terminal device 120 may transmit PUCCH and/or PUSCH and/or SRS (for example, the SRS may share/apply the same spatial domain filter with same indicated unified TCI state as for the PUCCH and/or PUSCH), using the same spatial domain filter as for the last PRACH transmission. For example, the last PRACH transmission may be the latest one before a PDCCH with the DCI.

In some embodiments, the terminal device 120 may be provided a configuration of unified TCI state (for example, TCI_State_r17) indicating a unified TCI state for a Pcell or a Pscell. In some embodiments, in case of a beam failure occurs or is detected in the Pcell or Pscell, the terminal device 120 may provide BFR MAC CE in message 3 (Msg3) or message A (MsgA) of contention based random access procedure. In some embodiments, after X symbols from a last symbol of a PDCCH reception that determines the completion of the contention based random access procedure, the terminal device 120 may monitor PDCCH in CORESETs, and/or receive PDSCH and/or aperiodic CSI-RS in a resource from a CSI-RS resource set (for example, the CSI-RS may share/apply the same indicated unified TCI state as for the PDCCH and/or PDSCH), using the same antenna port quasi co-location parameters as the ones associated with the index for the reference signal or with the reference signal. In some embodiments, after X symbols from a last symbol of a PDCCH reception that determines the completion of the contention based random access procedure, the terminal device 120 may transmit PUCCH and/or PUSCH and/or SRS (for example, the SRS may share/apply the same spatial domain filter with same indicated unified TCI state as for the PUCCH and/or PUSCH), using the same spatial domain filter as for the last PRACH transmission or using the same indicated UL TCI state or joint TCI state as for the PUCCH and/or PUSCH. For example, the last PRACH transmission may be the latest one before a PDCCH with the DCI.

In some embodiments, the terminal device 120 may be provided a configuration of unified TCI state (for example, TCI_State_r17) indicating a unified TCI state for a cell (for example, a Pcell or a Pscell or an Scell). In some embodiments, in case of a beam failure occurs or is detected in the cell, after X symbols from a last symbol of a PDCCH reception with a DCI scheduling a PUSCH with a same HARQ process number as for the transmission of a first PUSCH (For example, the terminal device 120 may provide or transmit the first PUSCH with index(es) for at least one of corresponding Scell(s) with radio link quality worse than Q_{out,I,R}, indication(s) of presence of q_{new} for corresponding Scell(s) and index(es) q_{new} for a periodic CSI-RS configuration or for a SS/PBCH block provided by higher layers, if any, for corresponding Scell(s)) and having a toggled new data indication (NDI) field value, the terminal device 120 may monitor PDCCH in CORESETs, and/or receive PDSCH and/or aperiodic CSI-RS in a resource from a CSI-RS resource set (for example, the CSI-RS may share/apply the same indicated unified TCI state as for the PDCCH and/or PDSCH), using the same antenna port quasi co-location parameters as the ones associated with the index for the reference signal or with the reference signal or with q_{new}, if any. In some embodiments, in case of a beam failure occurs or is detected in the cell, after X symbols from a last symbol of a PDCCH reception with a DCI scheduling a PUSCH with a same HARQ process number as for the transmission of a first PUSCH (for example, the terminal device 120 may provide or transmit the first PUSCH with index(es) for at least one of corresponding Scell(s) with radio link quality worse than Q_{out,I,R}, indication(s) of presence of q_{new} for corresponding Scell(s) and index(es) q_{new} for a periodic CSI-RS configuration or for a SS/PBCH block provided by higher layers, if any, for corresponding Scell(s)) and having a toggled new data indication (NDI) field value, the terminal device 120 may transmit PUCCH and/or PUSCH and/or SRS (for example, the SRS may share/apply the same spatial domain filter with same indicated unified TCI state as for the PUCCH and/or PUSCH), using the same spatial domain filter as the one corresponding to the reference signal or the reference signal Or q_{new}, if any.

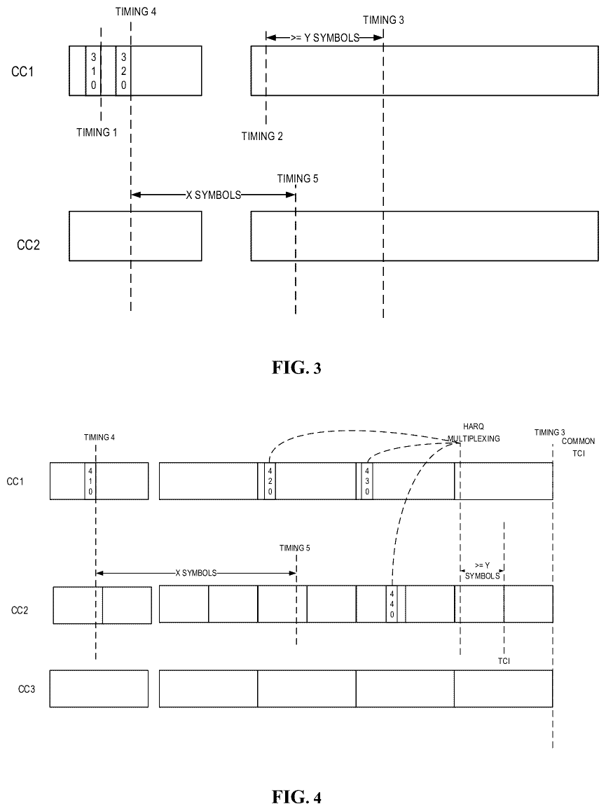

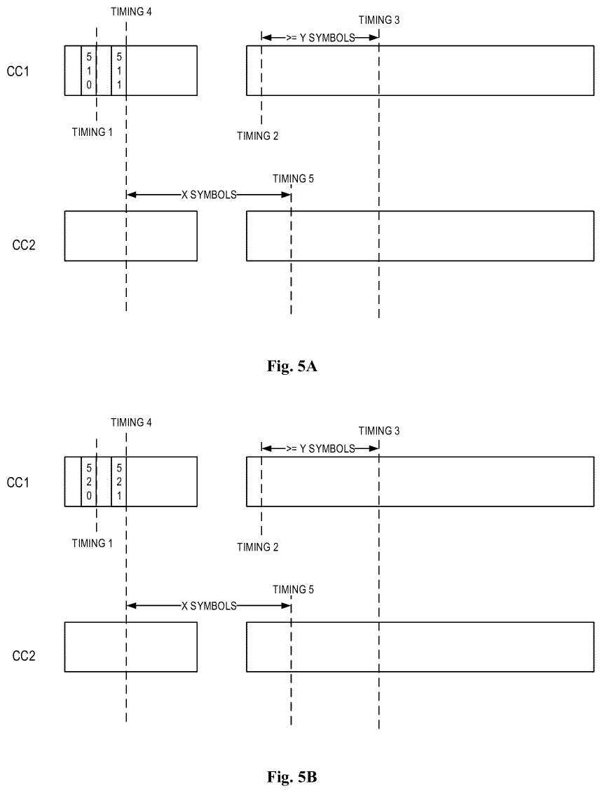

The network device 110 may transmit 2030 a PDCCH with a TCI state to the terminal device 120. The terminal device 120 may apply 2040 at least one quasi co-location (QCL) parameters for a first reference signal for downlink reception on the first CC until a first timing. Alternatively, the terminal device 120 may apply 2050 a spatial domain filter for the first reference signal or for a physical random access channel (PRACH) transmission for uplink transmission on the first CC until the first timing. Embodiments of the present disclosure are described with the reference to FIGS. 4 to 8B below: Timing 1 shown in FIGS. 3-8B can refer to the last symbol of a PDCCH with a TCI state indication. Timing 2 can refer to the last symbol of an acknowledgment (for example, a hybrid automatic repeat request (HARQ)-ACK). Timing 3 can refer to a stating timing of the first slot which is at least Y symbols after timing 2. Timing 4 can refer to the last symbol of a PDCCH with BFRR. Timing 5 can refer to a timing which is X symbols after timing 4.

In some embodiments, the terminal device 120 may be provided a configuration of unified TCI state (for example, TCI_State_r17) indicating a unified TCI state for a Pcell or a Pscell. In some embodiments, in case of a beam failure occurs or is detected in the Pcell or Pscell, after X symbols from a last symbol of a first PDCCH reception in a search space set (for example, provided by recovery SearchSpaceld) where the terminal device 120 detects a DCI with CRC scrambled by C-RNTI or MCS-C-RNTI, the terminal device 120 may monitor PDCCH in CORESETs, and/or receive PDSCH and/or aperiodic CSI-RS in a resource from a CSI-RS resource set (for example, the CSI-RS may share/apply the same indicated unified TCI state as for the PDCCH and/or PDSCH), using the same antenna port quasi co-location parameters as the ones associated with the index for the reference signal or with the reference signal until the first timing. In some embodiments, in case of a beam failure occurs or is detected in a Pcell or Pscell, after X symbols from a last symbol of a first PDCCH reception in a search space set (for example, provided by recovery SearchSpaceld) where the terminal device 120 detects a DCI with CRC scrambled by C-RNTI or MCS-C-RNTI, the terminal device 120 may transmit PUCCH and/or PUSCH and/or SRS (for example, the SRS may share/apply the same spatial domain filter with same indicated unified TCI state as for the PUCCH and/or PUSCH), using the same spatial domain filter as for the last PRACH transmission. For example, the last PRACH transmission may be the latest one before a PDCCH with the DCI until the first timing.

In some embodiments, the terminal device 120 may be provided a configuration of unified TCI state (for example, TCI_State_r17) indicating a unified TCI state for a Pcell or a Pscell. In some embodiments, in case of a beam failure occurs or is detected in the Pcell or Pscell, the terminal device 120 may provide BFR MAC CE in message 3 (Msg3) or message A (MsgA) of contention based random access procedure. In some embodiments, after X symbols from a last symbol of a PDCCH reception that determines the completion of the contention based random access procedure, the terminal device 120 may monitor PDCCH in CORESETs. and/or receive PDSCH and/or aperiodic CSI-RS in a resource from a CSI-RS resource set (for example, the CSI-RS may share/apply the same indicated unified TCI state as for the PDCCH and/or PDSCH), using the same antenna port quasi co-location parameters as the ones associated with the index for the reference signal or with the reference signal until the first timing. In some embodiments, after X symbols from a last symbol of a PDCCH reception that determines the completion of the contention based random access procedure, the terminal device 120 may transmit PUCCH and/or PUSCH and/or SRS (for example, the SRS may share/apply the same spatial domain filter with same indicated unified TCI state as for the PUCCH and/or PUSCH), using the same spatial domain filter as for the last PRACH transmission or using the same indicated UL TCI state or joint TCI state as for the PUCCH and/or PUSCH. For example, the last PRACH transmission may be the latest one before a PDCCH with the DCI until the first timing.

In some embodiments, the terminal device 120 may be provided a configuration of unified TCI state (for example, TCI_State_r17) indicating a unified TCI state for a cell (for example, a Pcell or a Pscell or an Scell). In some embodiments, in case of a beam failure occurs or is detected in the cell, after X symbols from a last symbol of a PDCCH reception with a DCI scheduling a PUSCH with a same HARQ process number as for the transmission of a first PUSCH (for example, the terminal device 120 may provide or transmit the first PUSCH with index(es) for at least one of corresponding Scell(s) with radio link quality worse than Q_{out,I.R}, indication(s) of presence of q_{new} for corresponding Scell(s) and index(es) q_{new} for a periodic CSI-RS configuration or for a SS/PBCH block provided by higher layers, if any, for corresponding Scell(s)) and having a toggled new data indication (NDI) field value, the terminal device 120 may monitor PDCCH in CORESETs, and/or receive PDSCH and/or aperiodic CSI-RS in a resource from a CSI-RS resource set (for example, the CSI-RS may share/apply the same indicated unified TCI state as for the PDCCH and/or PDSCH), using the same antenna port quasi co-location parameters as the ones associated with the index for the reference signal or with the reference signal or with q_{new}, if any, until the first timing. In some embodiments, in case of a beam failure occurs or is detected in the cell, after X symbols from a last symbol of a PDCCH reception with a DCI scheduling a PUSCH with a same HARQ process number as for the transmission of a first PUSCH (For example, the terminal device 120 may provide or transmit the first PUSCH with index(es) for at least one of corresponding Scell(s) with radio link quality worse than Q_{out,I.R}, indication(s) of presence of q_{new} for corresponding Scell(s) and index(es) q_{new} for a periodic CSI-RS configuration or for a SS/PBCH block provided by higher layers, if any, for corresponding Scell(s)) and having a toggled new data indication (NDI) field value, the terminal device 120 may transmit PUCCH and/or PUSCH and/or SRS (for example, the SRS may share/apply the same spatial domain filter with same indicated unified TCI state as for the PUCCH and/or PUSCH), using the same spatial domain filter as the one corresponding to the reference signal or the reference signal Or q_{new}, if any, until the first timing.

In some embodiments, the first timing may be the application timing of at least one indicated TCI state in a DCI. In some embodiments, after the first timing, the terminal device may apply the at least one indicated TCI state for downlink reception (for example, the downlink reception may be at least one of PDCCH, PDSCH and CSI-RS) and/or for uplink transmission (for example, the uplink transmission may be at least one of PUCCH, PUSCH and SRS). In some embodiments, after the first timing, the terminal device 120 may monitor PDCCH in CORESETs, and/or receive PDSCH and/or aperiodic CSI-RS in a resource from a CSI-RS resource set (for example, the CSI-RS may share/apply the same indicated unified TCI state as for the PDCCH and/or PDSCH), using the same antenna port quasi co-location parameters as the ones associated with the at least one indicated TCI state. For example, the at least one indicated TCI state may be a joint TCI state or a downlink TCI state. In some embodiments, after the first timing, the terminal device 120 may transmit PUCCH and/or PUSCH and/or SRS (for example, the SRS may share/apply the same spatial domain filter with same indicated unified TCI state as for the PUCCH and/or PUSCH), using the same spatial domain filter as the one corresponding to the at least one indicated TCI state. For example, the at least one indicated TCI state may be a joint TCI state or an uplink TCI state.

In some embodiments, there may be at least one condition to determine the first timing or to apply the at least one indicated TCI state for downlink reception and/or uplink transmission. In some embodiments, the at least one condition may comprise at least one of: the at least one TCI state is activated or indicated for the cell/CC or for the list of cells/CCs (for example, in case of beam indication for CA): at least one of the at least one TCI state is different from at least one of previous indicated TCI state(s) or different from a TCI state (for example, TCI_detect), wherein beam failure is detected based on the TCI state. For example, an indicated joint TCI state is different from the previous indicated/applied joint TCI state or different from TCI_detect. For another example, an indicated downlink TCI state is different from the previous indicated/applied downlink TCI state or different from TCI_detect); the at least one TCI state is indicated in a DCI in a PDCCH after or no earlier than X symbols after/from a last symbol of the BFRR: the at least one TCI state is indicated in a DCI in a PDCCH in a different cell/CC from a cell/CC in which beam failure is detected; and the at least one TCI state is indicated in a DCI in a PDCCH in the same cell/CC as the cell/CC in which beam failure is detected.

As shown in FIG. 4, in some embodiments, the terminal device 120 may detect the beam failure on the CC2. The network device 110 may transmit a PDCCH 310 with the TCI state to the terminal device 120. In this case, the terminal device 120 can apply at least one QCL parameter for a first reference signal on the CC2 until a first timing. Alternatively, the terminal device 120 can apply a spatial domain filter for the first reference signal or for a physical random access channel (PRACH) transmission for uplink transmission on the CC2 until the first timing. In other words, if a beam failure is detected on the CC2, q_{new} or last PRACH can be applied for downlink and/or uplink channel/signals on the CC 2, until a first timing. The term “q_{new}” can refer to a candidate beam identified by the UE in set q₁ which is the set of candidate beams. In some embodiments, the first timing may be an application timing of the indicated TCI state. In some embodiments, there may be at least one condition for applying the indicated TCI state. For example, the terminal device can apply at least one QCL parameter for a first reference signal on the CC2 when the first timing (e.g. Timing 3) is no earlier or later than Timing 5. In this way, the CC is out of control of common beam update/activation in a first duration, and back to be under control of common beam update/activation after a timing. The failed CC can still be under control of common beam update/activation for CA.

In some embodiments, if the at least one condition is fulfilled, the terminal device 120 can apply the TCI state (transmitted at 2030) for downlink reception and/or uplink transmission on the CC2 after the first timing. Alternatively, if the at least one condition is unfulfilled, the terminal device 120 can skip applying the TCI state (transmitted at 2030) on the CC2 after the first timing. In some embodiments, if the at least one condition is unfulfilled, the terminal device 120 can determine not to apply or determine to ignore the TCI state on the CC2 after the first timing. In other embodiments, if the at least one condition is unfulfilled, the terminal device 120 can continue to apply the at least one QCL parameters for downlink reception on the CC2 after the first timing. Alternatively, the terminal device 120 can continue to apply the spatial domain filter for uplink transmission on the CC2 after the first timing.

In some embodiments, the at least one condition can comprise that the TCI state is activated or indicated, for example, in case of beam indication for CA. In other embodiments, the at least one condition can comprise that the first TCI state is different from a previous indicated TCI state. In other words, the first TCI state is different from the previous indicated/applied TCI state or different from the TCI state based on which beam failure is detected on the second CC. In this way, on the other CC (e.g. without beam failure), it's possible that the indicated TCI state is not changed, while based on the unified TCI framework, even the indicated TCI state is not changed, it should be applied after application timing. If this unchanged TCI state is again applied to the CC2, beam failure may occur once again (the unchanged TCI is not suitable for the failed CC).

In other embodiments, the at least one condition can comprise that the first TCI state is indicated in a DCI on a second CC (for example, CC1). The second CC is different from the first CC, e.g. a reference CC, a Pscell, the same CC where BFRR is received. In some embodiments, the at least one condition can comprise that a source RS corresponding to QCL-Type with typeD in the first TCI state is different from a source RS corresponding to QCL-Type with typeD in the previous indicated TCI state. In this case, q_{new} applied to failed CC is based on the BFRR, in other words, the beam for failed CC follows indication from the CC with BFRR, then indicated TCI state can also follow this CC.

In some embodiments, the at least one condition can comprise that the source RS corresponding to QCL-Type with typeD in the first TCI state and the source RS corresponding to QCL-Type with typeD in the previous indicated TCI state are not quasi co-located with typed. In some embodiments, the at least one condition can comprise that the first TCI state is different from a TCI state associated with the beam failure detected on the CC2. In some embodiments, the at least one condition can comprise that the source RS corresponding to QCL-Type with typeD in the first TCI state is different from a source RS corresponding to QCL-Type with typeD in the TCI state associated with the beam failure detected on the first CC. Alternatively, the at least one condition can comprise that the source RS corresponding to QCL-Type with typeD in the first TCI state and the source RS corresponding to QCL-Type with typeD in the TCI state associated with the beam failure detected on the first CC are not quasi co-located with typed.

In some embodiments, the at least one condition can comprise that the first TCI state is indicated in a DCI on the second CC (i.e., CC1). In this way, beam failure occurs on the first CC, if a DCI with a TCI state can be detected on the first CC (at least after q_{new} applied, i.e. beam failure recovered), then the indicated TCI state in a DCI on the first CC can be regarded as suitable for the first CC. If there is no PDCCH on the first CC, or no BFR configured for the first CC, (actually no BFR), it seems PDSCH and uplink are better to follow reference CC always. Alternatively, the at least one condition can comprise that the first TCI state is indicated in downlink control information on the first CC.

In some embodiments, the at least one condition can comprise that the first CC is a secondary cell. In some embodiments, the at least one condition can comprise that the CC2 is not a reference CC. In some embodiments, the at least one condition can comprise that the first timing is no earlier or later than a second timing for applying the candidate beam. In some embodiments, the at least one condition can comprise that timing 3 is no earlier or later than timing 5. In some embodiments, the at least one condition can comprise that timing 1 is no earlier or later than timing 4 (PDCCH for TCI indication after a timing is considered). In some embodiments, the at least one condition can comprise that timing 1 is no earlier or later than timing 5 (PDCCH for TCI indication after a timing is considered). Otherwise, the indicated TCI state can be ignored or not applied after application timing for the CC2 (q_{new} or last PRACH can be still applied for the CC2 after an application timing of the indicated TCI state). For the other CC (no beam failure), the indicated TCI state can be applied based on unified TCI framework. Table 1 below shows an example according to some embodiments.

```
TABLE 1
  On Rel-17 unified TCI framework, for intra-cell beam management,
  after X symbols
from the UE receives the BFRR from NW, the UE assumes the same
QCL parameter as the
ones associated with the index q _{new} for all PDSCH /PDCCH receptions
in a CC, as well as
other signals/channels configured to sharing the same indicated Rel-17
TCI state as PDSCH
/PDCCH reception, until an application timing of an indicated unified
TCI state, wherein
the indicated unified TCI state is different from the previous applied
TCI state for the CC
and/or the unified TCI state is indicated in a PDCCH after X symbols
from BFRR on the
same CC.
    • The above applies to Rel-15 SpCell BFR , Rel-16 CBRA based
    SpCell
    BFR , and Rel-16 SCell BFR
    • Note: q _{new} is a candidate beam identified by the UE in set q₁. q₁
    is the set
    of candidate beams
  On Rel-17 unified TCI framework, after X symbols from the UE
  receives the BFRR
from NW, the UE uses the same UL spatial filter as the one associated
with the index q _{new}
or the last PRACH transmission for all PUSCH transmissions and all of
PUCCH resources
in a CC, as well as other signals/channels configured to sharing the same
indicated Rel-17
TCI state as PUSCH and all of PUCCH resources, until an application
timing of an
indicated unified TCI state, wherein the indicated unified TCI state is
different from the
previous applied TCI state for the CC and/or the unified TCI state is
indicated in a PDCCH
after X symbols from BFRR on the same CC.
    • The above applies to Rel-15/16 SpCell BFR , Rel-16 CBRA
    based SpCell
    BFR, and Rel-16 SCell BFR
    • Note: q _{new} is a candidate beam identified by the UE in set q₁. q₁
    is the set
    of candidate beams
    • FFS : UL PC control including q ᵤ , q _{d} , and closed loop index
```

In some embodiments, if the beam failure occurs on the CC2, TCI state for the CC2 follows the indication in PDCCH 440 on the CC2. In this case, a common TCI state update/activation cannot be applied to the CC2, and the CC2 can control itself. For example, after q_{new} is applied to the CC2, if there is a DCI on the CC2 indicates a TCI state, the indicated TCI state can be applied to the CC2 after application timing, and the indicated TCI state can be independent from TCI states indicated for other CCs. The Y symbols between the HARQ multiplexing for the PDCCH 420, 430 and 440 and the timing of applying the TCI in the PDCCH 440 can be based on the SCS of the CC2. The CC2 can be a set of failed CCs. The terminal device 120 may transmit the BFRR 410 on the CC1. The terminal device 120 can receive the PDCCH 420 with the TCI state indication and the PDCCH 430 with the TCI state indication on the CC1. The terminal device 120 can also receive the PDCCH 440 with the TCI state indication on the CC2. The terminal device 120 can apply the common TCI state which can be indicated in the PDCCH 420 and 430 for CA which does not comprise the CC2.

In some embodiments, if the first CC (i.e., CC2) is a reference CC or a primary cell or a primary secondary cell, the terminal device 120 can apply the at least one QCL parameters or the spatial domain filter on a third CC after an predetermined symbol (for example, X symbols) from a BFRR. In this case, there is no control resource set (COREST) configuration or a beam failure recovery (BFR) configuration for the third CC. In some embodiments, the third CC can refer to the first CC. In other embodiments, if the CC2 is not a reference CC or a primary cell or a primary secondary cell, the terminal device 120 may not apply the q_{new} for the CC2 to the third CC. In this case, the third CC can follow the indicated/activated TCI state. The predetermined number of symbols can be based on the smallest SCS between the first CC and CCs referring to the first CC and without CORESET/BFR configuration (the third CC). Table 2 below shows an example according to some embodiments.

```
TABLE 2
  On Rel-17 unified TCI framework, for intra-cell beam management,
  after X symbols
from the UE receives the BFRR from NW, the UE assumes the same
QCL parameter as the
ones associated with the index q _{new} for all PDSCH /PDCCH receptions
in a CC and CCs
referring to the CC if any (and the CCs has no CORESET configuration
and/or no BFR
configuration), as well as other signals/channels configured to sharing
the same indicated
Rel-17 TCI state as PDSCH /PDCCH reception.
    • The above applies to Rel-15 SpCell BFR , Rel-16 CBRA based
    SpCell
    BFR , and Rel-16 SCell BFR
    • Note: q _{new} is a candidate beam identified by the UE in set q₁. q₁
    is the set
    of candidate beams
  On Rel-17 unified TCI framework, after X symbols from the UE
  receives the BFRR
from NW, the UE uses the same UL spatial filter as the one associated
with the index q _{new}
or the last PRACH transmission for all PUSCH transmissions and all of
PUCCH resources
in a CC and CCs referring to the CC if any (and the CCs has no
CORESET configuration
and/or no BFR configuration), as well as other signals/channels
configured to sharing the
same indicated Rel-17 TCI state as PUSCH and all of PUCCH resources.
    • The above applies to Rel-15/16 SpCell BFR , Rel-16 CBRA based
    SpCell
    BFR, and Rel-16 SCell BFR
    • Note: q _{new} is a candidate beam identified by the UE in set q₁. q₁
    is the set
    of candidate beams
    • FFS : UL PC control including q ᵤ , q _{d} , and closed loop index
```

In some embodiments, the first TCI state can be different from the previous indicated TCI state. In this case, the terminal device 120 can apply the first TCI state on the first CC (the CC2) after the first timing. Alternatively, the first TCI state can be same as the previous indicated TCI state. In this case, the terminal device 120 can skip applying the first TCI state on the first CC. The terminal device 120 can determine to not apply or to ignore the first TCI state on the first CC after the first timing. The terminal device 120 can further continue to apply the at least one QCL parameters for downlink reception on the first CC after the first timing. Alternatively, the terminal device 120 can continue to apply the spatial domain filter for uplink transmission on the first CC after the first timing.

In some embodiments, the first TCI state can be different from the previous indicated TCI state. In this case, the terminal device 120 can skip the BFR after one of: an application timing of the first TCI state in the PDCCH; a reception timing of the first TCI state; a fifth timing for transmitting hybrid automatic repeat request; a predetermined number of symbols after a last symbol of the PDCCH; or successfully decoding the PDCCH.

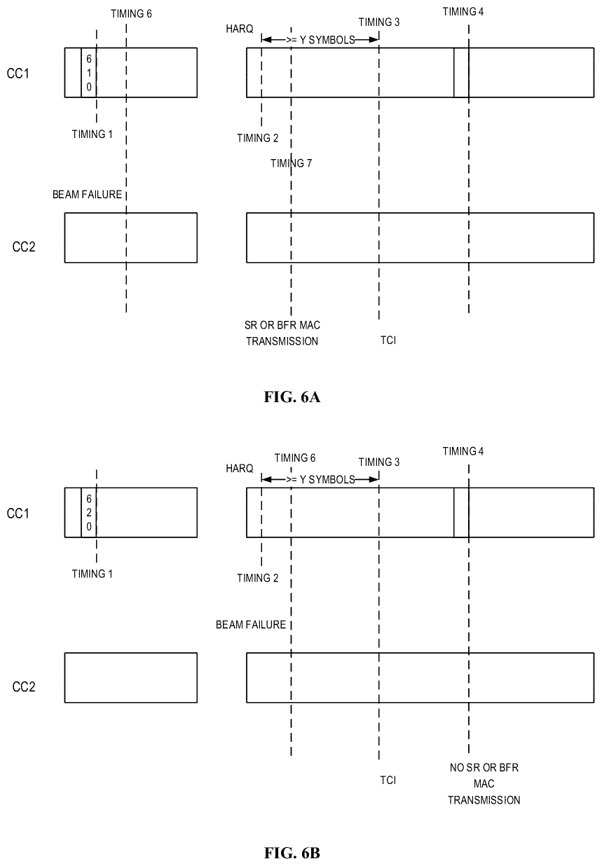

For example, as shown in FIG. 5A, the TCI state indicated in PDCCH 510 is different from the previous applied TCI state for CA, or the qcl-TypeD of the indicated TCI state is different from qcl-TypeD of previous applied TCI state for CA. The terminal device 120 can detect the PDCCH 510 comprising the indicated TCI state on the CC1 which is a reference CC or a primary secondary cell. The terminal device 120 can also transmit the BFRR on the CC1. In this case, the terminal device 120 can apply the indicated TCI state to the CC2 after timing 3. In addition, the terminal device 120 may not apply q_{new} after timing 5, in other words, q_{new} is cancelled or BFR is cancelled.

Alternatively, the indicated TCI state may not be changed. In this case, the terminal device 120 may not apply the indicated TCI state to the CC2. The terminal device 120 may apply q_{new} after timing 5. For example, as shown in FIG. 5B, the TCI state indicated in PDCCH 510 is same as the previous applied TCI state for CA, or the qcl-TypeD of the indicated TCI state is same as qcl-TypeD of previous applied TCI state for CA. In this case, the terminal device 120 may not apply the indicated TCI state to the CC2 after timing 3. In addition, the terminal device 120 may apply q_{new} after timing 5. Table 3 below shows an example according to some embodiments.

```
TABLE 3
  On Rel-17 unified TCI framework, for intra-cell beam management,
  after X symbols
from the UE receives the BFRR from NW (a timing), and if no new
indicated/activated TCI
state is applied before the timing, the UE assumes the same QCL
parameter as the ones
associated with the index q _{new} for all PDSCH /PDCCH receptions
in a CC , as well as other
signals/channels configured to sharing the same indicated Rel-17 TCI
state as PDSCH
/PDCCH reception, otherwise, the new indicated/activated TCI state is
applied.
    • The above applies to Rel-15 SpCell BFR , Rel-16 CBRA based
    SpCell
    BFR , and Rel-16 SCell BFR
    • Note: q _{new} is a candidate beam identified by the UE in set q₁. q₁
    is the set
    of candidate beams
  On Rel-17 unified TCI framework, after X symbols from the UE
  receives the BFRR
from NW(a timing), and if no new indicated/activated TCI state is applied
before the
timing, the UE uses the same UL spatial filter as the one associated with
the index q _{new} or
the last PRACH transmission for all PUSCH transmissions and all of
PUCCH resources in
a CC, as well as other signals/channels configured to sharing the same
indicated Rel-17 TCI
state as PUSCH and all of PUCCH resources, otherwise, the new
indicated/activated TCI
state is applied.
    • The above applies to Rel-15/16 SpCell BFR , Rel-16 CBRA based
    SpCell
    BFR, and Rel-16 SCell BFR
    • Note: q _{new} is a candidate beam identified by the UE in set q₁. q₁
    is the set
    of candidate beams
    • FFS : UL PC control including q ᵤ , q _{d} , and closed loop index
```

In some embodiments, an application timing or a reception timing of the first TCI state can be before a scheduling request or a transmission of a BFR medium access control control element (MAC CE) to the network device 110. In this case, terminal device 120 may skip the BFR. For example, if the counter for the beam failure exceeds the maximum count, the terminal device 120 may detect the beam failure on the CC2. In some embodiments, the BFR on the CC2 can be cancelled after application timing for the indicated TCI state (Timing 3) or reception timing of the indicated TCI state (Timing 1) or Timing 2 or Z symbols after last symbol of PDCCH with the indicated TCI state or after successfully decoding a DCI with the indicated TCI state. In some embodiments, the terminal device 120 may ignore q_{new}. In some embodiments, the terminal device 120 may not monitor BFRR. In some embodiments, the terminal device 120 may not apply q_{new} for downlink reception and/or uplink transmission.

In some embodiments, if a beam failure is declared in a cell/CC, and if a TCI state is indicated, the terminal device 120 may determine not to transmit a PUSCH with BFR MAC CE for the cell/CC for the beam failure. For example, if the indicated TCI state may be different from the previous indicated TCI state. For another example, the application timing for the indicated TCI state may be no later than or earlier than a timing when the BFR MAC CE for the cell/CC is prepared. For another example, the application timing for the indicated TCI state may be no later than or earlier than evaluation of the candidate beams according to the requirements for beam failure recovery has been completed.

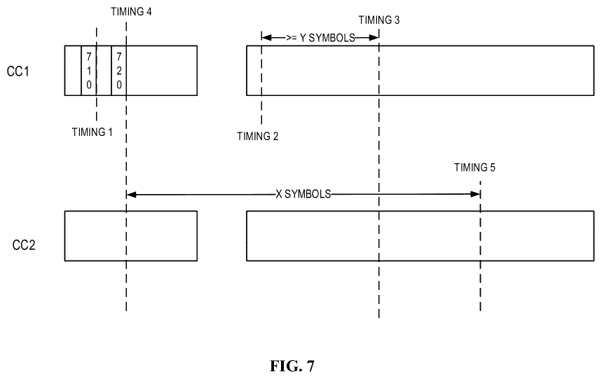

For example, as shown in FIG. 6A, the terminal device 120 can receive the PDCCH 610 with the TCI state indication on the CC1. The terminal device 120 can declare the beam failure at timing 6. The terminal device 120 may transmit the scheduling request or BFR MAC CE for the CC2 at timing 7. There is no BFRR monitoring after timing 3 and/or no q_{new} application after timing 3 and/or no SR and/or BFR MAC transmission for the CC2. Alternatively, as shown in FIG. 6B, the terminal device 120 can receive the PDCCH 620 with the TCI state indication on the CC1. The terminal device 120 can declare the beam failure at timing 6. The terminal device 120 may not transmit the scheduling request or BFR MAC CE (for example, in a PUSCH) for the CC2 at timing 7.

Furthermore, if the reception timing or application timing of a TCI state (e.g. a new TCI state) is before SR and/or BFR MAC CE is transmitted (e.g. after beam failure declared), the terminal device 120 can cancel the BFR on the cell. If the reception timing or application timing of a TCI state (e.g. a new TCI state) is not before SR and/or BFR MAC CE is transmitted (e.g. after beam failure declared), the terminal device 120 may not cancel the BFR on the cell. Table 4 below shows an example update according to some embodiments.

```
TABLE 4
All BFRs triggered for an (SpCell or) SCell shall be cancelled based on
at least two of
following timings which starts or ends earlier (e.g. the first or last
symbol for transmission):
  - HARQ-ACK to a TCI state indication (and/or based on some
  conditions in case 1) is
transmitted (e.g. after beam failure declared)
  - when a MAC PDU is transmitted and this PDU includes a
  BFR MAC CE or Truncated
BFR MAC CE which contains beam failure information of that Scell
  - a TCI state indication (and/or based on some conditions in
  case 1) is received (e.g. after
beam failure declared)
```

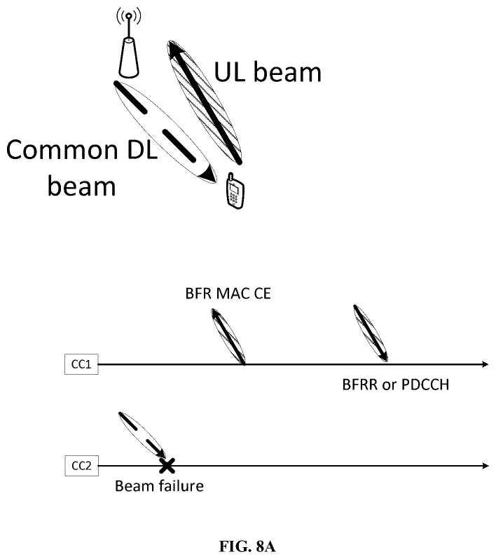

In some embodiments, the terminal device 120 may replace at least one QCL parameters of the previous indicated TCI state with the ones associated with the first reference signal on the first CC after a predetermined number of symbols from a beam recover response request. Alternatively, the terminal device 120 may replace at least one reference signals included in the previous indicated TCI state with the first reference signal on the first CC after a predetermined number of symbols from a beam recover response request. In these cases, the terminal device 120 may apply the first TCI state on the first CC based on an activation or an indication from the network device. For example, if a beam failure is detected on the CC2 (counter>=maxCoun), and if a unified TCI state different from previous one is indicated, the terminal device 120 can perform BFR MAC transmission and BFRR for the CC. In addition, after X symbols from BFRR, the terminal device 120 can replace the previous TCI state for the CC2 with q_{new}. The applied TCI state on the CC2 can be based on DCI indication or MAC activation. The failed CC can always follow common beam update/activation for CA, and only some TCI states may be updated/changed by q_{new}. In some embodiments, q_{new} may not be applied to downlink/uplink directly after X symbols from BFRR (unless the TCI state corresponding to q_{new} is indicated and after application timing). For example, as shown in FIG. 7, the terminal device 120 may receive the PDCCH 710 with the TCI state on the CC1. The terminal device 120 may not apply q_{new} but replace the TCI state after timing 5.

In some embodiments, the terminal device may apply the at least one QCL parameter or the spatial domain filter on the first CC until a reception of a MAC CE activation or until a reconfiguration of RRC (for example, the reconfiguration of RRC may include at least one configuration of a list of cells/CCs and/or a set of TCI states). For example, q_{new} can be applied for the CC2, until a new MAC CE activation common for at least one unified TCI state is received and/or applied or until the reconfiguration of RRC. In some embodiments, in case of more than one TCI state activated for the list of CCs, if beam failure occurs on the CC2, BFR procedure can be performed and common beam update/activation cannot be applied to the CC2. In some embodiments, q_{new} if any can be applied after Timing 5, until a new MAC CE is activated/applied and/or a TCI state from the new activated TCI states in the new MAC CE is indicated and applied or until the reconfiguration of RRC. In some embodiments, the CC2 doesn't refer to the reference CC and/or doesn't follow the common TCI state update/activation for CA until new MAC CE.

In some embodiments, the number of X symbols shown in FIGS. 4-7 can be different. For example, the number can be X1 symbols for Rel-15 Spcell BFR and the number can be X2 symbols for Rel-16 Scell BFR, and X1 is smaller than X2. Alternatively, the number can be X3 symbols for DL, and the number can be X4 symbols for UL, and X3 is smaller than X4.

In some embodiments, the terminal device 120 may only support one TCI state per band (intra-band CA). In this case, if BFR occurs in a subset of CCs, there can be different beams in the set of CCs. In some embodiments, one or more priorities can be defined for the beams. For example, if a reference CC or Spcell is failed, q_{new} for the CC or Spcell can have a higher priority. In this case, the terminal device 120 may not be required to monitor/receive/transmit based on indicated TCI state after q_{new} is applied for the reference CC or Spcell. Alternatively, if a secondary cell (Scell) is failed but Spcell is not failed), the TCI state indicated in the PDCC can have a higher priority. In this case, the terminal device may not be required to monitor/receive/transmit based on q_{new} for the failed Scell.

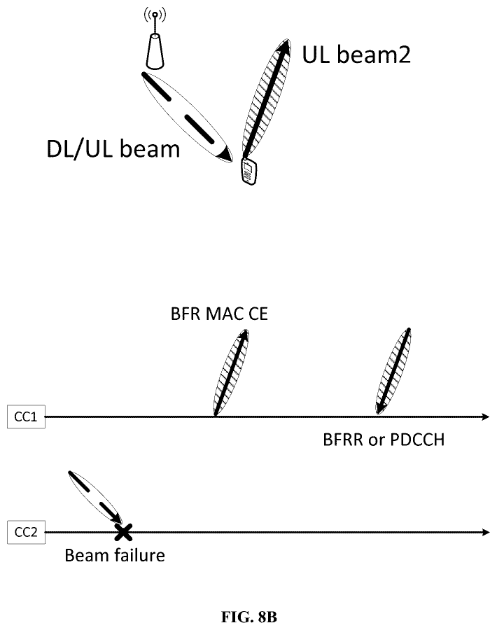

In some embodiments, a scheduling request or a BFR MAC CE can be transmitted on a second CC (i.e., the CC1). In this case, the terminal device 120 can monitor a BFRR or downlink control information on the second CC or a third CC based on at least one QCL parameters as the ones associated with a first reference signal or based on the first TCI state. For example, if beam failure is detected on the CC2, and SR and/or BFR MAC CE is transmitted on the CC1, the terminal device 120 may monitor BFRR or a DCI on the CC1 and/or a third CC based on QCL parameters same with q_{new} or DL source RS (e.g. PL-RS) associated with the applied UL TCI state. Alternatively, the terminal device 120 may monitor BFRR or a DCI on the CC1 and/or the third CC based on QCL parameters corresponding to a TCI state. The TCI state can be configured with at least different QCL typed source RS with current/previous unified TCI state, for example, a TCI state with lowest ID from those configured for the channels/RSs not sharing the indicated TCI state for UE dedicated PDSCH/PDCCH, such as TCI state activated for CSS, for CSI-RS. For example, as shown in FIG. 8A, the terminal device 120 may detect the beam failure on the common DL beam on the CC2. In this case, the terminal device 120 may transmit the BFR MAC CE on the UL beam on the CC1. The terminal device 120 may also monitor the BFRR or PDCCH on the UL beam on the CC1.

In other embodiments, a downlink TCI state and an uplink TCI state can be separated. In this case, the terminal device 120 can transmit at least one of: a scheduling request or BFR MAC CE based on the uplink TCI state. The terminal device 120 may further monitor a BFRR or PDCCH after a sixth timing based on at least one QCL parameters as the ones associated with the uplink TCI state. For example, in some embodiments, on a cell (for example, an Spcell or a reference cell), and if the indicated DL TCI and indicated UL TCI may not be a case of beam alignment (in case of separate DL/UL TCI configuration), or when there is more UL TCI states than DL TCI states, the terminal device 120 can perform PUCCH based BFR if beam failure is declared. If beam failure detected (based on the DL TCI state(s)), SR and/or BFR MAC CE can be transmitted based on at least one UL TCI state, for example, beam for UL TCI state(s) is different from the DL TCI states, (PL RS for UL TCI is different or not QCLed (typeD) with DL TCI state). The terminal device 120 may monitor BFRR or PDCCH after a timing based on QCL parameters same with source RS for the UL TCI state (e.g. PL RS or downlink RS for spatial relation info for the UL TCI state). Otherwise, RACH based BFR can be performed if beam failure is declared. For example, as shown in FIG. 8B, the terminal device 120 may detect the beam failure on the DL/UL beam on the CC2. In this case, the terminal device 120 may transmit the BFR MAC CE on the UL beam 2 on the CC1. The terminal device 120 may also monitor the BFRR or PDCCH on the UL beam 2 on the CC1.

In some embodiments, for Pcell or Pscell, after PRACH or BFR MAC CE in Msg3 or MsgA transmission, BFRR may be PDCCH_1 or the first/earlier (first or last symbol) one of PDCCH_1 and PDCCH_2. In some embodiments, the BFRR may be a first PDCCH reception with a DCI format with TCI state indication, wherein the PDCCH may be in the same cell of the BFR MAC CE transmission or in any cell (except CC2) and wherein the TCI state may be a new TCI state different from previous one. Alternatively, the BFRR may be a first PDCCH reception with a DCI format scheduling a PUSCH transmission with a same HARQ process number as for the transmission of the first PUSCH and having a toggled NDI field value. For Scell, after SR and/or BFR MAC CE transmission, BFRR may be PDCCH_1 or the first/earlier (first or last symbol) one of PDCCH_1 and PDCCH_2. In some embodiments, the BFRR may be a PDCCH reception with a DCI format with TCI state indication, wherein the PDCCH may be in the same cell of the BFR MAC CE transmission or in any cell (except CC2), wherein the TCI state may be a new TCI state different from previous one. In some embodiments, the BFRR may be a first PDCCH reception in a search space set provided by recoverySearchSpaceld for which the UE detects a DCI format with CRC scrambled by C-RNTI or MCS-C-RNTI or a PDCCH reception that determines the completion of the contention based random access procedure. Furthermore, if the BFRR is PDCCH_1, the indicated TCI state can be applied after application timing or q_{new} can be applied X symbols after BFRR. Alternatively, if the BFRR is PDCCH_2, q_{new} can be applied X symbols after the BFRR.

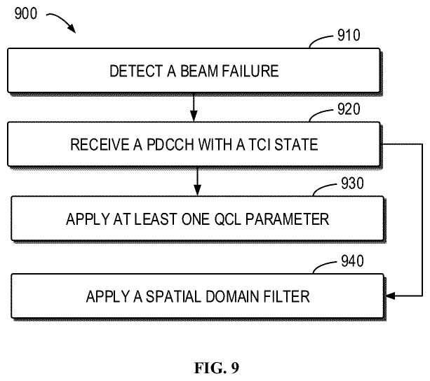

FIG. 9 shows a flowchart of an example method 900 in accordance with an embodiment of the present disclosure. Only for the purpose of illustrations, the method 900 can be implemented at a terminal device 120 as shown in FIG. 1.

At block 910, the terminal device 120 detects a beam failure on a first component carrier (CC).

At block 910, the terminal device 120 receives, from the network device 110, a physical downlink control channel (PDCCH) with a first transmission configuration indicator (TCI) state.

At block 930, the terminal device 120 applies at least one quasi co-location (QCL) parameters for a first reference signal for downlink reception on the first CC until a first timing. Alternatively, at block 940, the terminal device 120 applies a spatial domain filter for the first reference signal or for a physical random access channel (PRACH) transmission for uplink transmission on the first CC until the first timing. In some embodiments, the first timing is an application timing of the first TCI state in the PDCCH.

In some embodiments, if at least one condition is fulfilled, the terminal device 120 may apply the first TCI state for downlink reception and/or uplink transmission on the first CC after the first timing. In some embodiments, if the at least one condition is unfulfilled, the terminal device 120 may cause applying the first TCI state on the first CC after the first timing to be skipped. In some embodiments, if the at least one condition is unfulfilled, the terminal device 120 may determine to not apply or ignore the first TCI state on the first CC after the first timing. In some embodiments, if the at least one condition is unfulfilled, the terminal device 120 may continue to apply the at least one QCL parameters for downlink reception on the first CC after the first timing. Alternatively, the terminal device 120 may continue to apply the spatial domain filter for uplink transmission on the first CC after the first timing.

In some embodiments, the at least one condition comprises one or more of: the first TCI state is activated or indicated: the first TCI state is different from a previous indicated TCI state: a source RS corresponding to QCL-Type with typeD in the first TCI state is different from a source RS corresponding to QCL-Type with typeD in the previous indicated TCI state: the source RS corresponding to QCL-Type with typeD in the first TCI state and the source RS corresponding to QCL-Type with typeD in the previous indicated TCI state are not quasi co-located with typeD: the first TCI state is different from a TCI state associated with the beam failure detected on the first CC: the source RS corresponding to QCL-Type with typeD in the first TCI state is different from a source RS corresponding to QCL-Type with typeD in the TCI state associated with the beam failure detected on the first CC: the source RS corresponding to QCL-Type with typeD in the first TCI state and the source RS corresponding to QCL-Type with typeD in the TCI state associated with the beam failure detected on the first CC are not quasi co-located with typeD: the first TCI state is indicated in downlink control information on a second CC: the first TCI state is indicated in downlink control information on the first CC: the first CC is a secondary cell: the first CC is not a reference CC: the first timing is no earlier or later than a second timing for applying the candidate beam: a third timing of the reception of the first TCI state is no earlier or later than a fourth timing for a reception of a beam failure recovery request (BFRR): or the third timing of the reception of the first TCI state is no earlier or later than the second timing for applying the at least one QCL parameters or the spatial domain filter.

In some embodiments, the first CC is a reference CC or a primary cell or a primary secondary cell. In this case, the terminal device 120 may apply the at least one QCL parameters or the spatial domain filter on a third CC after an predetermined symbol from a BFRR, wherein there is no control resource set (COREST) configuration or a beam failure recovery (BFR) configuration for the third CC.

In some embodiments, the first TCI state is different from the previous indicated TCI state. In this case, the terminal device 120 may apply the first TCI state on the first CC after the first timing.

In some embodiments, the first TCI state is same as the previous indicated TCI state. In this case, the terminal device 120 may cause applying the first TCI state on the first CC to be skipped. The terminal device 120 may determine to not apply or ignore the first TCI state on the first CC after the first timing. The terminal device 120 may continue to apply the at least one QCL parameters for downlink reception on the first CC after the first timing. Alternatively, the terminal device 120 may continue to apply the spatial domain filter for uplink transmission on the first CC after the first timing.

In some embodiments, if the first TCI state is different from the previous indicated TCI state, the terminal device 120 may cause a BFR to be skipped after one of: an application timing of the first TCI state in the PDCCH: a reception timing of the first TCI state: a fifth timing for transmitting hybrid automatic repeat request: a predetermined number of symbols after a last symbol of the PDCCH: or successfully decoding the PDCCH.

In some embodiments, the terminal device 120 may cause a BFR to be skipped, in accordance with a determination that an application timing or a reception timing of the first TCI state is before a scheduling request or a transmission of a BFR medium access control control element (MAC CE) to the network device.

In some embodiments, the terminal device 120 may replace at least one quasi co-location (QCL) parameters of the previous indicated TCI state with the ones associated with the first reference signal on the first CC after a predetermined number of symbols from a beam recover response request. Alternatively, the terminal device 120 may replace at least one reference signals included in the previous indicated TCI state with the first reference signal on the first CC after a predetermined number of symbols from a beam recover response request. The terminal device 120 may apply the first TCI state on the first CC based on an activation or an indication from the network device.

In some embodiments, the terminal device 120 may apply the at least one QCL parameter or the spatial domain filter on the first CC until a reception of a MAC CE activation. In some embodiments, if a scheduling request or a BFR MAC CE is transmitted on a second CC, the terminal device 120 may monitor a BFRR or downlink control information on the second CC or a third CC based on at least one QCL parameter as the ones associated with a first reference signal or based on the first TCI state.

In some embodiments, a downlink TCI state and an uplink TCI state are separated. In this case, if the beam failure is detected based on the downlink TCI state, the terminal device 120 may transmit at least one of: a scheduling request or BFR MAC CE based on the uplink TCI state. The terminal device 120 may monitor a BFRR or PDCCH after a sixth timing based on at least one QCL parameters as the ones associated with the uplink TCI state.

In some embodiments, a terminal device comprises circuitry configured to: detect, a beam failure on a first component carrier (CC): receive, from a network device, a physical downlink control channel (PDCCH) with a first transmission configuration indicator (TCI) state; and apply at least one quasi co-location (QCL) parameters as the ones associated with a first reference signal for downlink reception on the first CC until a first timing, or apply a spatial domain filter as the one associated with the first reference signal or as for a physical random access channel (PRACH) transmission for uplink transmission on the first CC until the first timing.

In some embodiments, the first timing is an application timing of the first TCI state in the PDCCH.

In some embodiments, if at least one condition is fulfilled, the terminal device comprises circuitry configured to apply the first TCI state for downlink reception and/or uplink transmission on the first CC after the first timing. In some embodiments, if the at least one condition is unfulfilled, the terminal device comprises circuitry configured to cause applying the first TCI state on the first CC after the first timing to be skipped. In some embodiments, if the at least one condition is unfulfilled, the terminal device comprises circuitry configured to determine to not apply or ignore the first TCI state on the first CC after the first timing. In some embodiments, if the at least one condition is unfulfilled, the t terminal device comprises circuitry configured to continue to apply the at least one QCL parameters for downlink reception on the first CC after the first timing. Alternatively, the terminal device comprises circuitry configured to continue to apply the spatial domain filter for uplink transmission on the first CC after the first timing.

In some embodiments, the at least one condition comprises one or more of: the first TCI state is activated or indicated: the first TCI state is different from a previous indicated TCI state: a source RS corresponding to QCL-Type with typeD in the first TCI state is different from a source RS corresponding to QCL-Type with typeD in the previous indicated TCI state: the source RS corresponding to QCL-Type with typeD in the first TCI state and the source RS corresponding to QCL-Type with typeD in the previous indicated TCI state are not quasi co-located with typeD: the first TCI state is different from a TCI state associated with the beam failure detected on the first CC: the source RS corresponding to QCL-Type with typeD in the first TCI state is different from a source RS corresponding to QCL-Type with typeD in the TCI state associated with the beam failure detected on the first CC: the source RS corresponding to QCL-Type with typeD in the first TCI state and the source RS corresponding to QCL-Type with typeD in the TCI state associated with the beam failure detected on the first CC are not quasi co-located with typeD: the first TCI state is indicated in downlink control information on a second CC: the first TCI state is indicated in downlink control information on the first CC: the first CC is a secondary cell: the first CC is not a reference CC: the first timing is no earlier or later than a second timing for applying the candidate beam: a third timing of the reception of the first TCI state is no earlier or later than a fourth timing for a reception of a beam failure recovery request (BFRR): or the third timing of the reception of the first TCI state is no earlier or later than the second timing for applying the at least one QCL parameters or the spatial domain filter.

In some embodiments, the first CC is a reference CC or a primary cell or a primary secondary cell, the terminal device comprises circuitry configured to apply the at least one QCL parameters or the spatial domain filter on a third CC after an predetermined symbol from a BFRR, wherein there is no control resource set (COREST) configuration or a beam failure recovery (BFR) configuration for the third CC.

In some embodiments, the first TCI state is different from the previous indicated TCI state, the terminal device comprises circuitry configured to apply the first TCI state on the first CC after the first timing.

In some embodiments, the first TCI state is same as the previous indicated TCI state, the terminal device comprises circuitry configured to cause applying the first TCI state on the first CC to be skipped. The terminal device comprises circuitry configured to determine to not apply or ignore the first TCI state on the first CC after the first timing. The terminal device comprises circuitry configured to continue to apply the at least one QCL parameters for downlink reception on the first CC after the first timing. Alternatively, the terminal device comprises circuitry configured to continue to apply the spatial domain filter for uplink transmission on the first CC after the first timing.

In some embodiments, if the first TCI state is different from the previous indicated TCI state, the terminal device comprises circuitry configured to cause a BFR to be skipped after one of: an application timing of the first TCI state in the PDCCH: a reception timing of the first TCI state: a fifth timing for transmitting hybrid automatic repeat request: a predetermined number of symbols after a last symbol of the PDCCH: or successfully decoding the PDCCH.

In some embodiments, the terminal device comprises circuitry configured to cause a BFR to be skipped, in accordance with a determination that an application timing or a reception timing of the first TCI state is before a scheduling request or a transmission of a BFR medium access control control element (MAC CE) to the network device.

In some embodiments, the terminal device comprises circuitry configured to replace at least one quasi co-location (QCL) parameters of the previous indicated TCI state with the ones associated with the first reference signal on the first CC after a predetermined number of symbols from a beam recover response request. In some embodiments, the terminal device comprises circuitry configured to replace at least one reference signals included in the previous indicated TCI state with the first reference signal on the first CC after a predetermined number of symbols from a beam recover response request. In some embodiments, the terminal device comprises circuitry configured to apply the first TCI state on the first CC based on an activation or an indication from the network device.

In some embodiments, the terminal device comprises circuitry configured to apply the at least one QCL parameter or the spatial domain filter on the first CC until a reception of a MAC CE activation. In some embodiments, if a scheduling request or a BFR MAC CE is transmitted on a second CC, the terminal device comprises circuitry configured to monitor a BFRR or downlink control information on the second CC or a third CC based on at least one QCL parameter as the ones associated with a first reference signal or based on the first TCI state.

In some embodiments, a downlink TCI state and an uplink TCI state are separated. In some embodiments, if the beam failure is detected based on the downlink TCI state, the terminal device comprises circuitry configured to transmit at least one of: a scheduling request or BFR MAC CE based on the uplink TCI state. In some embodiments, the terminal device comprises circuitry configured to monitor a BFRR or PDCCH after a sixth timing based on at least one QCL parameters as the ones associated with the uplink TCI state.

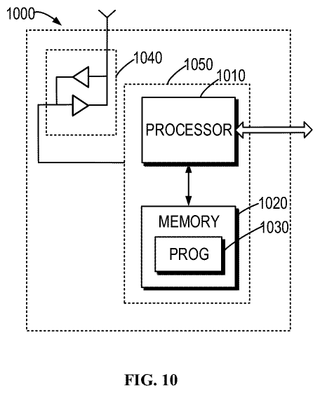

FIG. 10 is a simplified block diagram of a device 1000 that is suitable for implementing embodiments of the present disclosure. The device 1000 can be considered as a further example implementation of the network device 110, the TRP 130 and/or the terminal device 120 as shown in FIG. 1. Accordingly, the device 1000 can be implemented at or as at least a part of the network device 110, the TRP 130 and/or the terminal device 120 as shown in FIG. 1.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIG. 1 to FIG. 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 10 and 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flow charts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A communication method, comprising:
detecting, at a terminal device, a beam failure on a first component carrier (CC);
receiving, from a network device, a physical downlink control channel (PDCCH) with a first transmission configuration indicator (TCI) state; and
applying at least one quasi co-location (QCL) parameters as the ones associated with a first reference signal for downlink reception on the first CC until a first timing, or
applying a spatial domain filter as the one associated with the first reference signal or as for a physical random access channel (PRACH) transmission for uplink transmission on the first CC until the first timing.

2. The method of claim 1, wherein the first timing is an application timing of the first TCI state in the PDCCH.

3. The method of claim 1, further comprising at least one of:
in accordance with a determination that at least one condition is fulfilled, applying the first TCI state for downlink reception and/or uplink transmission on the first CC after the first timing;
in accordance with a determination that the at least one condition is unfulfilled, causing applying the first TCI state on the first CC after the first timing to be skipped;
in accordance with a determination that the at least one condition is unfulfilled, determining to not apply or ignore the first TCI state on the first CC after the first timing; and
in accordance with a determination that the at least one condition is unfulfilled, continuing to apply the at least one QCL parameters for downlink reception on the first CC after the first timing, or
continuing to apply the spatial domain filter for uplink transmission on the first CC after the first timing.

4. The method of claim 3, wherein the at least one condition comprises one or more of:
the first TCI state is activated or indicated;
the first TCI state is different from a previous indicated TCI state;
a source RS corresponding to QCL-Type with typeD in the first TCI state is different from a source RS corresponding to QCL-Type with typeD in the previous indicated TCI state;
the source RS corresponding to QCL-Type with typeD in the first TCI state and the source RS corresponding to QCL-Type with typeD in the previous indicated TCI state are not quasi co-located with typeD;
the first TCI state is different from a TCI state associated with the beam failure detected on the first CC;
the source RS corresponding to QCL-Type with typeD in the first TCI state is different from a source RS corresponding to QCL-Type with typeD in the TCI state associated with the beam failure detected on the first CC;
the source RS corresponding to QCL-Type with typeD in the first TCI state and the source RS corresponding to QCL-Type with typeD in the TCI state associated with the beam failure detected on the first CC are not quasi co-located with typeD;
the first TCI state is indicated in downlink control information on a second CC;
the first TCI state is indicated in downlink control information on the first CC;
the first CC is a secondary cell;
the first CC is not a reference CC;
the first timing is no earlier or later than a second timing for applying the candidate beam;
a third timing of the reception of the first TCI state is no earlier or later than a fourth timing for a reception of a beam failure recovery request (BFRR); or
the third timing of the reception of the first TCI state is no earlier or later than the second timing for applying the at least one QCL parameters or the spatial domain filter.

5. The method of claim 1, wherein the first CC is a reference CC or a primary cell or a primary secondary cell, and the method further comprises:
applying the at least one QCL parameters or the spatial domain filter on a third CC after an predetermined symbol from a BFRR, wherein there is no control resource set (COREST) configuration or a beam failure recovery (BFR) configuration for the third CC.

6. The method of claim 1, wherein the first TCI state is different from the previous indicated TCI state, and wherein the method further comprises:
applying the first TCI state on the first CC after the first timing.

7. The method of claim 1, wherein the first TCI state is same as the previous indicated TCI state, and wherein the method further comprises at least one of:
causing applying the first TCI state on the first CC to be skipped;
determining to not apply or ignore the first TCI state on the first CC after the first timing; and
continuing to apply the at least one QCL parameters for downlink reception on the first CC after the first timing, or
continuing to apply the spatial domain filter for uplink transmission on the first CC after the first timing.

8. The method of claim 1, further comprising:
in accordance with a determination that the first TCI state is different from the previous indicated TCI state, causing a BFR to be skipped after one of;
an application timing of the first TCI state in the PDCCH;
a reception timing of the first TCI state;
a fifth timing for transmitting hybrid automatic repeat request;
a predetermined number of symbols after a last symbol of the PDCCH: or successfully decoding the PDCCH.

9. The method of claim 1, further comprising:
causing a BFR to be skipped, in accordance with a determination that an application timing or a reception timing of the first TCI state is before a scheduling request or a transmission of a BFR medium access control control element (MAC CE) to the network device.

10. The method of claim 1, further comprising:
replacing at least one quasi co-location (QCL) parameters of the previous indicated TCI state with the ones associated with the first reference signal on the first CC after a predetermined number of symbols from a beam recover response request: or
replacing at least one reference signals included in the previous indicated TCI state with the first reference signal on the first CC after a predetermined number of symbols from a beam recover response request; and
applying the first TCI state on the first CC based on an activation or an indication from the network device.

11. The method of claim 1, wherein applying the at least one quasi co-location (QCL) parameters or the spatial domain filter on the first CC until the first timing comprises:
applying the at least one quasi co-location (QCL) parameters or the spatial domain filter on the first CC until a reception of a MAC CE activation.

12. The method of claim 1, further comprising:
in accordance with a scheduling request or a BFR MAC CE is transmitted on a second CC, monitoring a BFRR or downlink control information on the second CC or a third CC based on at least one quasi co-location (QCL) parameters as the ones associated with a first reference signal or based on the first TCI state.

13. The method of claim 1, wherein a downlink TCI state and an uplink TCI state are separated, and wherein the method further comprises:
in accordance with a determination that the beam failure is detected based on the downlink TCI state, transmitting at least one of: a scheduling request or BFR MAC CE based on the uplink TCI state; and
monitoring a BFRR or PDCCH after a sixth timing based on at least one QCL parameters as the ones associated with the uplink TCI state.

14. A terminal device comprising:
a processor; and
a memory coupled to the processor and storing instructions thereon, the instructions, when executed by the processor, causing the terminal device to perform the method according to any of claims 1-13.

15. A computer readable medium having instructions stored thereon, the instructions, when executed on at least one processor, causing the at least one processor to perform the method according to any of claims 1-13.
